(19) United States
(12) Patent Application Publication
(10) Pub. No.: US 2026/0162012 A1
(43) Pub. Date: Jun. 11, 2026

(54) TIME SERIES DATA LABELING SYSTEM AND OPERATION METHOD THEREOF

(71) Applicant: Korea Electronics Technology Institute, Seongnam-si (KR)

(72) Inventors: JaeWon Moon, Seoul (KR); Seung Woo Kum, Yongin-si (KR); Seungtaek Oh, Seongnam-si (KR)

(21) Appl. No.: 19/392,907

(22) Filed: Nov. 18, 2025

(30) Foreign Application Priority Data
Dec. 5, 2024 (KR) 10-2024-0180010
Jul. 9, 2025 (KR) 10-2025-0092567
Nov. 13, 2025 (KR) 10-2025-0171787

(51) Int. Cl. G06N 20/00

(52) U.S. Cl. CPC G06N 20/00

(57) ABSTRACT

Proposed are a time-series data labeling system and an operating method thereof. The operating method may be performed by the time-series data labeling system. The method may include receiving first time-series data and source information of the first time-series data, and setting a label segment that is a labeling target segment in the first time-series data based on the input of a user and performing labeling of the first time-series data by assigning a label to the label segment. The method may also include generating labeling result structuring information of the first time-series data based on the source information of the first time-series data and the results of the labeling of the first time-series data. The method may further include displaying the labeling result structuring information of the first time-series data through an output interface device.

### CROSS-REFERENCE TO RELATED APPLICATIONS

This application claims priority under 35 U.S.C. § 119 to Korean Patent Application Nos. 10-2024-0180010, filed on Dec. 5, 2024, 10-2025-0092567, filed on Jul. 9, 2025, and 10-2025-0171787, filed on Nov. 13, 2025, the disclosure of which is incorporated herein by reference in its entirety.

### BACKGROUND

### Technical Field

The present disclosure relates to a time-series data analysis technology. Specifically, embodiments of the present disclosure relate to a system for dividing time-series data according to various criteria and methods and assigning labels to the divided data by combining a plurality of labeling strategies and automation functions, and an operating method thereof.

### Description of Related Technology

A data labeling system has been focused on static data, such as an image or a natural language, and has difficulty in being applied to dynamic data, such as time-series data. In particular, the time-series data has characteristics, such as a time axis, periodicity, the similarity of a pattern, and abnormality detection.

### SUMMARY

One aspect is a time-series data labeling system which is specialized for the division and labeling of time-series data and an operating method thereof.

Another aspect is to provide various division methods (e.g., a cycle/time/ratio/number) specialized for time-series data.

Another aspect is to support various patterns, statistics, and abnormality detection-based automatic/semi-automatic labeling.

Another aspect is to provide a label assignment UI according to a user definition criterion.

Another aspect is to provide automation (automation labeling pipeline) of a process of assigning a label to new data by using labeled data in the training of a labeling model.

Another aspect is to provide minimization of work to repeat the same labeling by automating the training of the labeling model.

Another aspect is to support a visual interface and customizing by considering collaboration and scalability.

Aspects of the present disclosure are not limited to those described herein, and other aspects not described above may be evidently understood by those skilled in the art from the following description.

Another aspect is a time-series data labeling system and an operating method thereof.

Another aspect is a time-series data labeling system that includes a processor and memory configured to store one or more commands executed by the processor.

The one or more commands include a command to receive first time-series data and source information of the first time-series data, a command to set a label segment that is a labeling target segment in the first time-series data based on the input of a user and to perform the labeling of the first time-series data by assigning a label to the label segment based on the input of a user, and a command to generate labeling result structuring information of the first time-series data based on the source information of the first time-series data and the results of the labeling of the first time-series data and to display the labeling result structuring information of the first time-series data through an output interface device.

Another aspect is an operating method of the time-series data labeling system that includes receiving first time-series data and source information of the first time-series data, setting a label segment that is a labeling target segment in the first time-series data based on the input of a user and performing labeling of the first time-series data by assigning a label to the label segment, and generating labeling result structuring information of the first time-series data based on the source information of the first time-series data and the results of the labeling of the first time-series data and displaying the labeling result structuring information of the first time-series data through an output interface device.

Embodiments of the present disclosure provide the time-series data labeling system capable of integrally managing the entire process for the division, interpretation, labeling, automation, result storage, and expression of time-series data, and the operating method thereof. Specifically, the time-series data labeling system has the following effects.

### Support of Labeling Specialized for Time-Series Data

It is possible to change a label unit by flexibly dividing time-series data on the basis of a time range, the number of data, a ratio, and a cycle that are directly defined by a user by considering a time axis-based special data structure.

Various analysis purposes can be handled because both static and dynamic segments can be included as labeling targets by surpassing the existing fixed window-based uniform division method.

### Integration and Provision of Labeling Strategies Using Various Methods

It is possible to integrally provide various time-series-specialized labeling strategies, such as manual selection, statistics-based labeling (e.g., an inter quantile range (IQR)), outlier detection, similar pattern exploration, and a clustering base.

A user can directly designate a segment or can automatically or semi-automatically assign a label through an algorithm.

It is possible to selectively apply a plurality of labeling strategies within one system.

### Precise Labeling for Variable Length and Multi-Time-Series Data

When time-series data consists of several sets, an accurate location of each label can be designated based on a data number and an index.

It is possible to assign individual labels or a plurality of labels to the same time-series data with respect to a partial segment, an overlap segment, or an atypical segment (i.e., a label assignment unit can be flexibly operated).

Precise labeling can be performed on all of or some variable length time-series sets.

### Structuring of Label Results and Expression Based on Metadata

It is possible to clearly express the meaning of a label, a generate method, and a data location by structuring and storing the source (Source), definition (Label Set), and result (Label Result) of a label.

It is possible to secure the tracking possibility and reproducibility of a label, including the access path and identifier of source data having various formats (e.g., CSV, a DB, and a sensor).

It is advantageous for condition-based re-extraction and post-processing because filter information (e.g., a specific feature, a tag, and a time condition) for labeling results are stored and reused.

### Automatic Training and Application of Labeling Results

It is possible to automatically train a classifier (e.g., ML or DL) based on am assigned label and to automatically assign a label to similar and new data by using a trained classifier subsequently.

A human-in-the-loop structure, such as a user check request, is possible based on prediction confidence (i.e., a confidence score).

It is possible to gradually improve labeling quality through consistent training (i.e., fine-tuning).

### Intuitive and Collaborable Visual User Interface

There is provided an interface through which time-series data can be displayed, a segment that is a label assignment target, can be selected by drags and clicks, and labels can be assigned.

Labeling collaboration between several users is possible, and version management and history tracking for a label are possible.

Repetitive work is made efficient by automatically recommending a frequently used labeling pattern.

### Industrial Utilization and Versatility

The time-series data labeling system according to embodiments of the present disclosure may be used in purposes, such as the abnormality detection, state classification, and event search of time-series data that are generated in various industry areas, such as manufacturing, health care, environments, energy, smart cities, and finance.

The time-series data labeling system according to embodiments of the present disclosure may be used as a universal time-series labeling platform because various data formats, label criteria, and automation strategies are integrated in the time-series data labeling system.

As a result, according to embodiments of the present disclosure, a system specialized for time-series data is provided. The entire process relating to a labeling process is constructed in one integrated flow. Specifically, according to embodiments of the present disclosure, a time-series labeling method based on the existing fragmentary static method and manual work is improved by providing the time-series data labeling system capable of 1) precise segment designation, 2) interpretation/labeling using various methods, 3) automation, and 4) structured storage and recycling.

Effects of the present disclosure which may be obtained in the present disclosure are not limited to the aforementioned effects, and other effects not described above may be evidently understood by a person having ordinary knowledge in the art to which the present disclosure pertains from the following description.

### BRIEF DESCRIPTION OF THE DRAWINGS

FIG. 1 is a block diagram illustrating a construction of a time-series data labeling system according to an embodiment of the present disclosure.

FIGS. 2 to 6 are views relating to the type and label segments of time-series data.

FIGS. 7 to 9 are views illustrating examples in which a label segment is generated by dividing time-series data.

FIG. 10 is an exemplary diagram of similar pattern-based labeling.

FIG. 11 is an exemplary diagram of condition-based labeling.

FIG. 12 is an exemplary diagram of clustering-based labeling.

FIGS. 13A, 13B, 14A, 14B, 15A, and 15B are views for describing the association of time-series data and labeling result structuring information.

FIGS. 16A, 16B, and 16C are exemplary diagrams of labeling result structuring information.

FIG. 17 is a flowchart for describing an operating method of the time-series data labeling system according to an embodiment of the present disclosure.

FIG. 18 is a flowchart for describing an operating method of the time-series data labeling system according to an embodiment of the present disclosure.

FIG. 19 is a diagram illustrating a plurality of time-series data sub-sequences.

FIG. 20 illustrates an example in which one timestamp is set as the step gap of a sliding window.

FIG. 21 is a block diagram illustrating the construction of a time-series data labeling module based on a large language model (LLM), which is mounted on the time-series data labeling system.

FIG. 22 is a flowchart for describing an operating method of the time-series data labeling system according to an embodiment of the present disclosure.

### DETAILED DESCRIPTION

A data division and labeling technique into which such characteristics have been properly incorporated has not yet been proposed. Furthermore, training data that is necessary for the generation of a model for automation requires refining, splitting, or pattern-based processing unlike common data. In order to divide the time-series data into a meaningful unit and to assign a label to data divided to comply with utilization purposes, an elaborate division and labeling assignment method is required.

Embodiments of the present disclosure provide a time-series data labeling system specialized for time-series data and an operating method thereof. Table 1 is a table in which conventional technology and technology proposed by embodiments of the present disclosure are compared.

TABLE 1

| | | Technology proposed by |
|---|---|---|
| | Conventional | embodiments of the |
| Item | technology | present disclosure |
| Time-series | Basically a fixed window | Flexible division according to |
| data division | (window-based division). | a plurality of criteria, such |
| | In general, time or | as a time range, a number, a |
| | number-based single | ratio, and a cycle. Both |
| | condition | static and dynamic division |
| | | methods are supported. |
| Labeling | Assign labels to all of | Selective labeling is possible |
| unit | segments having a fixed | for a variable length segment, |
| | length en bloc | a partial segment, an overlap |
| | | segment, and some defined |
| | | segments |
| Labeling | Based on manual or | An automation method that uses |
| method | external script, fixed | a plurality of strategies, |
| | method (rule), and some | such as manual, statistics, a |
| | machine training | similar pattern, clustering, |
| | | and outliers, and is |
| | | specialized for time-series |
| | | data. |
| Automation | Require separate model | Automatic training of a user |
| | training after manual | label-based classifier. |
| | labeling. A labeling | Automatic prediction and label |
| | system and a training | assignment are possible for |
| | system are separated. | subsequent and new data. |
| | | Corresponding information |
| | | is applied to a labeler. |
| Interface | Coda and a UI for | Labeling is interactively |
| | simple UI segment | applied based on time-series |
| | selection are not | visualization |
| | supported | |
| User | Difficult to perform | User adaptation rule/function/ |
| definition | custom processing; | combination, such as filter |
| processing | mainly fixed | condition, division criteria, |
| | functions | and labeling methods, are |
| | | possible. A multi-user |
| | | collaboration function is |
| | | included. |

Advantages and characteristics of the present disclosure and a method for achieving the advantages and characteristics will become apparent from embodiments described in detail later in conjunction with the accompanying drawings. However, the present disclosure is not limited to the disclosed embodiments, but may be implemented in various different forms. The embodiments are merely provided to complete the present disclosure and to fully notify a person having ordinary knowledge in the art to which the present disclosure pertains to the category of the present disclosure. The present disclosure is merely defined by the category of the claims. Terms used in this specification are used to describe embodiments and are not intended to limit the present disclosure. In this specification, an expression of the singular number includes an expression of the plural number unless clearly defined otherwise in the context. The term “comprises” and/or “comprising” used in this specification does not exclude the presence or addition of one or more other components, steps, operations and/or components in addition to mentioned components, steps, operations and/or components.

Terms, such as a first and a second, may be used to describe various components, but the components should not be restricted by the terms. The terms may be used to only distinguish one component from the other components. Accordingly, a first component may be named a second component without departing from the scope of a right of the present disclosure. Likewise, a second component may also be named a first component.

When it is described that one component is “connected” or “coupled” to the other component, it should be understood that one component may be directly connected or coupled to the other component, but a third component may exist between the two components. In contrast, when it is described that one component is “directly connected to” or “directly coupled to” the other component, it should be understood that a third component does not exist between the two components. Other expressions for describing relations between components, that is, “between ˜”, “just between ˜”, “adjacent to ˜”, and “neighboring ˜”, should be likewise construed.

In describing the present disclosure, a detailed description of a related known technology will be omitted if it is deemed to make the subject matter of the present disclosure unnecessarily vague.

Hereinafter, embodiments of the present disclosure are described in detail with reference to the accompanying drawings. In describing the present disclosure, in order to facilitate general understanding of the present disclosure, the same reference numeral is used for the same mean regardless of the reference numeral.

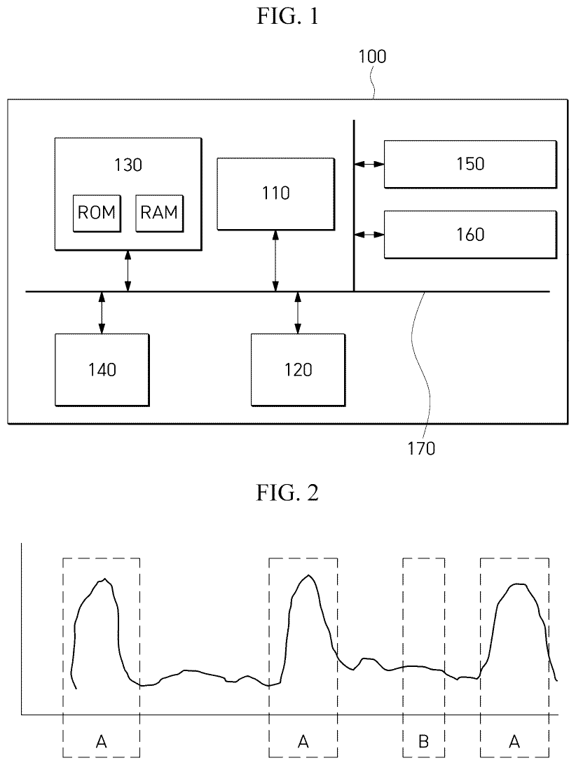

FIG. 1 is a block diagram illustrating a construction of a time-series data labeling system (hereinafter referred to as a “labeling system”) according to an embodiment of the present disclosure.

The labeling system 100 may execute an operating method of the time-series data labeling system (hereinafter referred to as an “operating method”) according to an embodiment of the present disclosure.

Referring to FIG. 1, the labeling system 100 may include at least one processor 110, memory 130, an input interface device 150, an output interface device 160, and a storage device 140 that communicate with each other through a bus 170. The labeling system 100 may further include a communication device 120 combined with a network.

The labeling system 100 illustrated in FIG. 1 is an embodiment. The components of the labeling system 100 according to an embodiment of the present disclosure are not limited to the embodiment illustrated in FIG. 1, and a component may be added, changed, or deleted, if necessary.

The processor 110 may be a central processing unit (CPU) or may be a semiconductor device that executes a computer-readable instruction stored in the memory 130 or the storage device 140. The memory 130 and the storage device 140 may each include various types of volatile or non-volatile storage media. For example, the memory 130 may include read only memory (ROM) and random access memory (RAM). In an embodiment of the present specification, the memory 130 may be disposed inside or outside the processor 110 and connected to the processor 110 through various known means. The memory 130 includes various types of volatile or nonvolatile storage media, and may include ROM or RAM, for example.

Accordingly, an embodiment of the present disclosure may be implemented as a method implemented in a computer or may be implemented as a non-transitory computer-readable medium in which a computer-executable instruction has been stored. In an embodiment, when being executed by the processor 110, a computer-readable instruction may perform a method according to at least one aspect of this writing.

The communication device 120 may transmit or receive a wired signal or a wireless signal.

Furthermore, the operating method of the labeling system 100 according to an embodiment of the present disclosure may be implemented in the form of a program instruction which may be executed through various computer means, and may be recorded on a computer-readable medium.

The computer-readable medium may include a program instruction, a data file, and a data structure alone or in combination. A program instruction recorded on the computer-readable medium may be specially designed and constructed for an embodiment of the present disclosure or may be known and available to those skilled in the computer software field. The computer-readable medium may include a hardware device configured to store and execute the program instruction. For example, the computer-readable medium may include magnetic media such as a hard disk, a floppy disk, and a magnetic tape, optical media such as CD-ROM and a DVD, magneto-optical media such as a floptical disk, ROM, RAM, and flash memory. The program instruction may include not only a machine code produced by a compiler, but a high-level language code capable of being executed by a computer through an interpreter.

The processor 110 implements the operating method by executing one or more computer-readable commands stored in the memory 130 or the storage device 140.

The one or more commands include a command to receive first time-series data and source information of the first time-series data, a command to set a label segment that is a labeling target segment in the first time-series data based on the input of a user and to perform the labeling of the first time-series data by assigning a label to the label segment based on the input of a user, and a command to generate labeling result structuring information of the first time-series data based on the source information of the first time-series data and the results of the labeling of the first time-series data and to display the labeling result structuring information of the first time-series data through an output interface device.

The input of the user may include designating, by the processor 110, a data pattern that is used to extract a candidate label segment from the first time-series data and selecting, by the processor 110, one or more label segments from the extracted candidate label segment based on the data pattern.

The input of the user may include designating, by the labeling system, a data pattern that is used to extract a candidate label segment from the first time-series data and selecting, by the labeling system, one or more label segments from the extracted candidate label segment based on the data pattern.

The one or more commands may further include a command to train a classification model that is an artificial intelligence model that performs labeling of time-series data, by using the first time-series data and the labeling result structuring information of the first time-series data.

The one or more commands may further include a command to receive second time-series data and source information of the second time-series data and a command to perform the labeling of the second time-series data by using the classification model and to display the results of the labeling of the second time-series data through the output interface device.

The one or more commands may further include a command to generate labeling result structuring information of the second time-series data based on the source information of the second time-series data and the results of the labeling of the second time-series data and to display the labeling result structuring information of the second time-series data through the output interface device.

The one or more commands may further include a command to re-train the classification model by using the second time-series data and the labeling result structuring information of the second time-series data.

The labeling result structuring information of the first time-series data is hierarchically structured information, and may include information that identifies and accesses the first time-series data and information on data items that are used in filtering in a process of labeling the first time-series data process.

The command to train the classification model may include requesting the feedback from the user when prediction confidence calculated by the classification model is lower than a threshold and to fine-tuning the classification model based on the feedback from the user.

The feedback may include excluding data having prediction confidence lower than the threshold, among the first time-series data, from training data for the training of the classification model.

Hereinafter, the labeling system 100 according to an embodiment of the present disclosure is described in detail.

### Division of Type of and Label Segment of Time-Series Data

The existing labeling tools basically adopt a method of assigning labels by being limited to some variable segments (e.g., before and after an event occurs) in all of time-series data. Many research data provide data sets to which labels have been assigned for each identically sliced datum. However, in an actual site, various time-series data storage methods and label assignment scenarios are present. Accordingly, a labeling strategy also needs to be changed.

For example, a case may be classified as follows depending on the number of given time-series data and label assignment target segments (i.e., labeling target segments and hereinafter denoted as “label segments”).
1) A case in which labels are individually assigned to specific segments in one independent time-series datum
2) A case in which a label is individually assigned to each of all of segments in each time-series datum when a plurality of independent time-series data is given
3) A case in which one independent time-series datum is divided at the same or variable segment and labels are individually assigned to the divided segments

In order to effectively process various time-series data formats, the labeling system 100 according to embodiments of the present disclosure defines the type of time-series data having a two-step structure and uses the time-series data so that the classification model, that is, a labeler, can interpret the time-series data. Specifically, the labeling system 100 classifies the type of time-series data on the basis (i.e., a time-series data classification criterion) of two elements, such as 1) a data unit sequence ID and 2) a time point set, and interprets the time-series data based on the classification result of the type of time-series data. The meaning of the time-series data classification criterion is as follows.
1) Data unit sequence ID (sequence ID): unique identification information for identifying each time-series data collection unit (e.g., a sensor, a user, or equipment)
2) Time point set: a set of time points (e.g., a start time point, an end time point, and an abnormality occurrence time point) that defines a meaningful segment within corresponding time-series data

For example, when a plurality of label segments is present within one time-series datum, the number of data unit sequence IDs is 1, and several time point sets are present within the one time-series datum. In contrast, when several time-series data are input simultaneously, a unique data unit sequence ID is assigned to each time-series datum, and independent time point sets are present for each sequence.

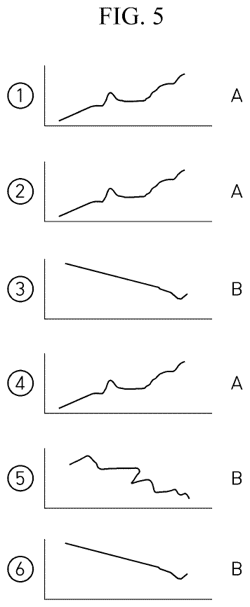

FIGS. 2 to 6 are views relating to the type and label segments of time-series data. In FIGS. 2 to 4 and 6, time-series data is interpreted as a single time-series structure in which the number of data unit sequence IDs is one (Full Scenario). In FIG. 5, time-series data is interpreted as a multi-time-series structure in which the number of data unit sequence IDs is six (Slice Scenario).

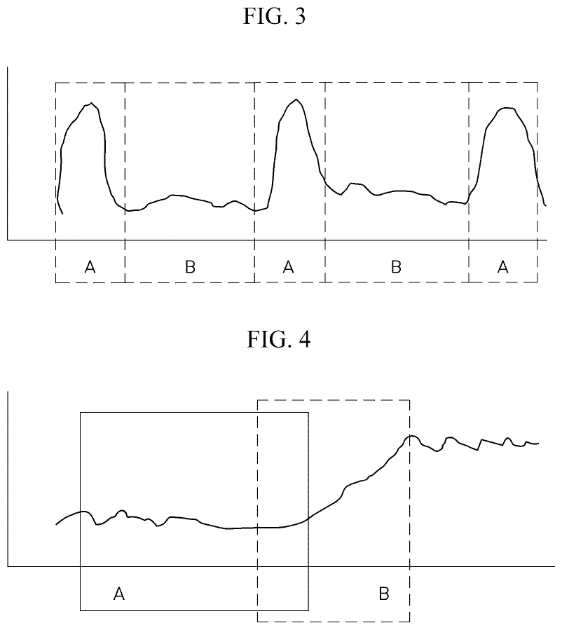

FIG. 2 illustrates an example in which a label is assigned to a specific segment in all of time-series data. FIG. 3 illustrates an example in which labels are assigned to all of divided segments that do not overlap in all of time-series data. Furthermore, FIG. 4 illustrates an example in which a label is independently assigned to each divided segment for which an overlap is permitted in all of time-series data.

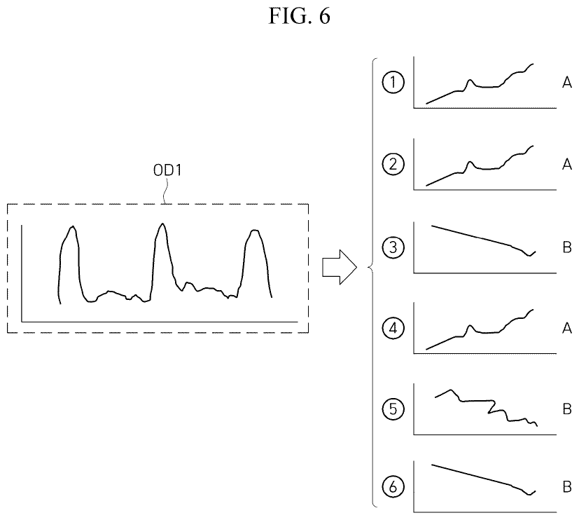

FIG. 5 is an example in which individual labels are assigned to all of segments of independent time-series data that are divided and provided from the beginning, respectively. FIG. 6 is an example in which labels are assigned to original data OD1, that is, one time-series datum, by uniformly dividing the original data according to a specific condition, and is an example in which one time-series datum is used as slice data.

All of time-series units include individually interpretable time point sets. Through such a structure, various data interpretations, such as synchronous/asynchronous labeling and repetitive segment analysis, are possible.

The above-described method for classifying types of time-series data is designed in consideration of the diversity of time-series data that are publicly available and widely utilized in practice.

A method of defining a label segment is described. A unit (i.e., a label segment) by which a label is assigned to time-series data may be divided as follows.
1) Dynamic segments: an arbitrary segment (e.g., a specific segment of time-series data selected by using a mouse) directly designated by a user
2) Static segments: a segment (e.g., everyday or every 10,000) automatically (e.g., cyclically) generated according to a predetermined criterion

FIGS. 2 to 4 are examples of cases in which label segments are dynamic segments. The lengths of the label segments are different. That is, FIGS. 2 to 4 illustrate cases in which the label segment is a flexible segment that is changed by a user, not a fixed unit. A label is assigned to only a specific segment.

FIG. 5 illustrates a case in which a fully different data set is manually or automatically divided and one independent label is assigned to each time-series datum. In embodiments of the present disclosure, such a label segment is treated as a static segment. Furthermore, in embodiments of the present disclosure, if a data set, such as that illustrated in FIG. 5, is generated by dividing one long time-series datum as a fixed segment as illustrated in FIG. 6, such a label segment is treated as a static segment.

### Flexibility of Method of Setting Label Segment and Assigning Label

A label segment, that is, a label assignment target in the labeling system 100, may be set as a “fixed unit” as in a conventional technology, and may also be set as a flexible segment that is different depending on a user on the basis of a user interface that is provided through the input interface device 150.

For example, a user may select one or more of the following various methods through a user interface that is provided by the labeling system 100, may designate a label segment in a target time-series data, and may assign a label to the label segment.
1) Selectively assign a label to only a specific label segment: selects only some region (e.g., 10%) of all of segments and assigns labels to the some region
2) Individually assign labels to overlapped label segments: For example, although a label segment A overlaps a label segment B 30%, a user may assign different labels to the label segments A and B
3) Assign the same label to completely independent label segments: For example, a case in which labels are assigned to data that are heterogeneous, but are considered as the same type
4) Assign a label to the entire variable length segment: Labels are assigned to all of segments having different lengths for each label segment, but are determined as a meaning unit or statistics unit. For example, the labeling system 100 may define a boundary condition for a specific pattern or event defined by an expert, may set a segment that satisfies a corresponding condition as a label segment, may set a label, may set a label segment by detecting a point at which statistical characteristics are changed in time-series data, and may assign a label based on the statistics. Furthermore, the labeling system 100 may set a variable label segment by using an LSTM, a transformer-based deep learning model, or a clustering scheme, and may assign a label to the set label segment based on a model output, statistics, or the input of a user.

The labeling system 100 according to embodiments of the present disclosure can overcome the limits of fixed length-based labeling and is capable of meaning unit-based or variable length-based labeling.

### Generation of Label Segment Through Division of Time-Series Data

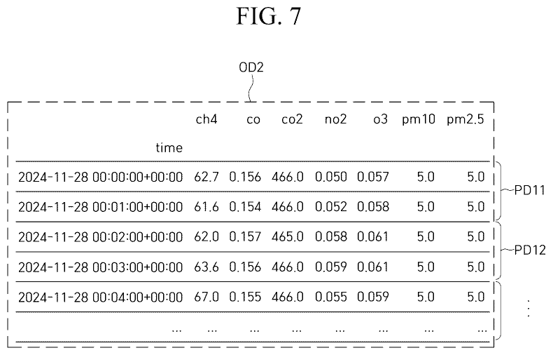

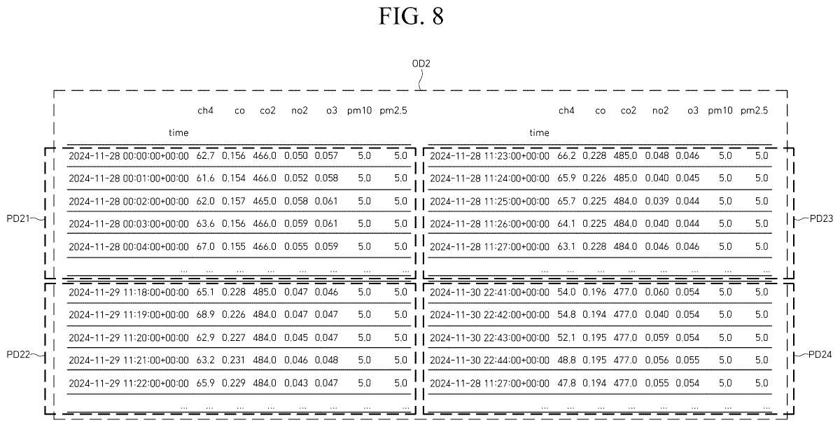

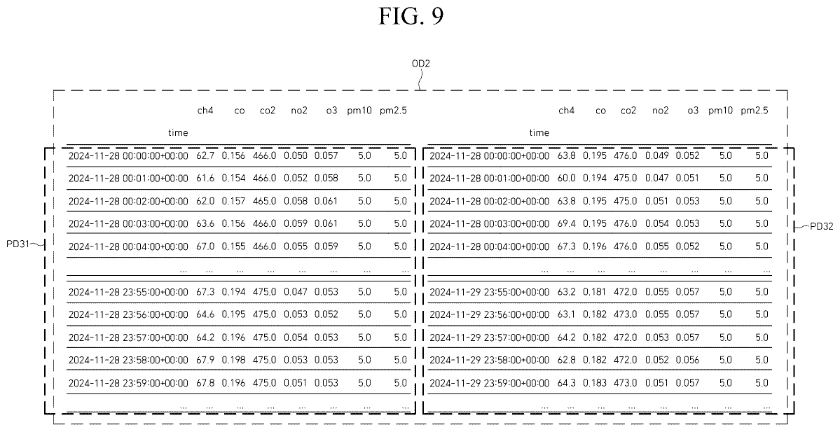

The labeling system 100 may generate a label segment by dividing time-series data according to a criterion desired by a user based on a user interface that is provided through the input interface device 150. The following is an example of a method of dividing time-series data, which may be selected by a user through a user interface that is configured in the labeling system 100 and provided by the input interface device 150.
1) Time range filter division: time-series data is divided so that the time-series data can be analyzed by filtering a specific time zone or a specific interval. For example, it is possible to generate a label segment by extracting and dividing only a specific time zone or a specific interval or removing only a specific time zone or a specific interval and then dividing the specific time zone or specific interval.
2) Number-based division: a label segment is generated by equally dividing time-series data in an N-time point (or record) unit. FIG. 7 is an example in which label segments, such as PD11 and PD12, are generated by dividing original data OD2, that is, time-series data, by two time points.
3) Ratio-based equal division: all of time-series data are equally divided at a set ratio (e.g., 5 equal divisions or 10 equal divisions). FIG. 8 is an example in which four label segments PD21, PD22, PD23, and PD24 are generated by quadrisecting original data OD2, that is, time-series data.
4) Cycle-based division: time-series data is repetitively divided in a cycle (e.g., three days, a week, or a year) designated by a user. FIG. 9 is an example in which label segments PD31 and PD32 are generated by dividing original data OD2 according to the date.
5) Combination of division methods: for example, a user may divide time-series data by setting a complex condition on which the cycle-based division and the time range filter division are combined or the cycle-based division and the number-based division are combined through a user interface provided by the input interface device 150.

### Manual/Automatic Labeling Scheme

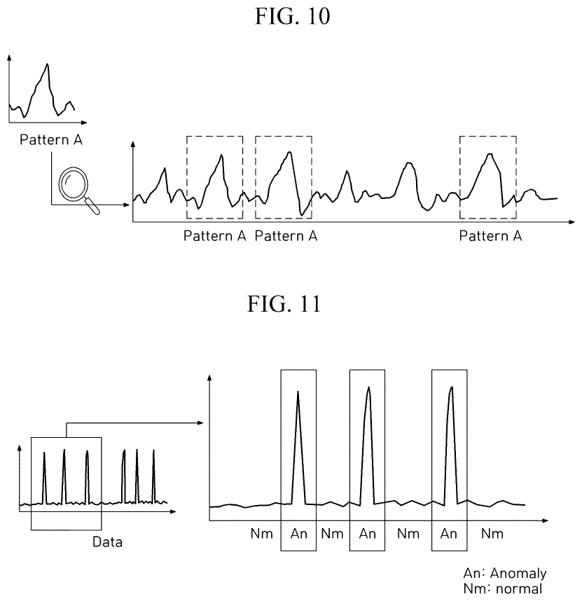

The labeling system 100 may assign a label to each label segment by using the following labeling schemes.
1) Manual labeling: a method of directly assigning, by a user, a label. That is, a user may select a previously generated label segment through a user interface (e.g., an input through a mouse) provided by the input interface device 150 and directly designate a label name.
2) Similar pattern-based labeling: a user may select a specific label segment, that is, a similarity determination criterion, through a user interface and designate a label. The labeling system 100 may assign the same label having the selected label segment to another label segment having a pattern similar to that of the label segment selected by the user. FIG. 10 is an exemplary diagram of a case in which when a user designates a pattern of time-series data to be searched for, the labeling system 100 assigns the same label by searching for data having a pattern similar to the designated pattern. For example, a user may designate the range (i.e., a lower limit and an upper limit) of corresponding features by selecting specific data features (refer to data items) in the user interface. The labeling system 100 may search for segments that comply with the corresponding range in the features designated by the user, and may display the retrieved segments. The user may select a segment that will be a label assignment target, among the displayed segment, may set the selected segment as a label segment, and may designate a desired label to a corresponding label segment. The labeling system 100 may search for another segment having similarity with the label segment selected by the user, which is equal to or greater than a set threshold, and may assign the same label as the label designated by the user. A scheme for calculating the similarity may include various schemes. For example, the labeling system 100 may calculate similarity between a designated data pattern and a label segment by using similarity calculation schemes, such as dynamic time warping (DTW), Euclid similarity, cosine similarity between embedding vectors, symbolic aggregate approximation (SAX), and deep learning (e.g., an LSTM and a transformer).

The label segment may be previously designated prior to labeling, but may be designated during a process of performing the labeling. The same is true of the condition-based labeling or the clustering-based labeling in addition to the similar pattern-based labeling.
3) Condition-based labeling: a method of automatically assigning a label by determining a label segment on the basis of a set condition. In this case, statistics, such as a minimum value, a maximum value, an interquartile range (IRQ), and a z-score, may be used to set the condition. The condition may be set by a user, and the labeling system 100 may propose the condition to a user through the statistics analysis of time-series data, and the user may set the condition.

For example, when the number of features that falls outside a threshold having a preset minimum value and a preset maximum value or a threshold having a lower limit and upper limit of the IQR, among the data features of a label segment, is greater than a predetermined limit, the labeling system 100 may assign an “anomaly” label to the corresponding label segment, and may assign a “normal” label to a label segment not having such a condition. As another example, when any one feature that falls outside a threshold having a preset minimum value and a preset maximum value or a threshold having a lower limit and upper limit of the IQR is present in the data features of a label segment, the labeling system 100 may assign an “anomaly” label to the corresponding label segment.

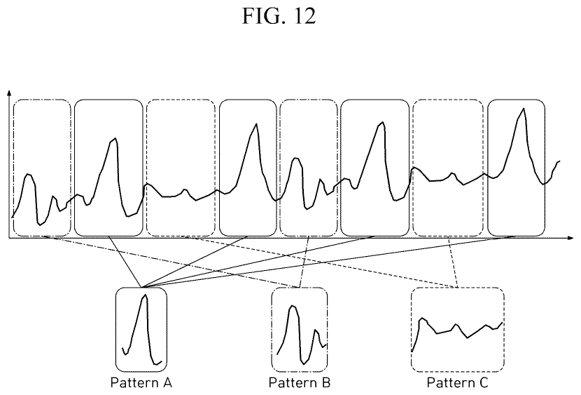

FIG. 11 is an exemplary diagram in which the condition-based labeling scheme has been applied. Specifically, FIG. 11 is an exemplary diagram of a case in which an “anomaly (An)” label and a “normal (Nm)” label have been assigned by dividing a segment into an anomaly segment and a normal segment based on a time point or time point set having a value that falls outside a set normal range based on statistics and setting the anomaly segment and the normal segment as label segments. Such a process may be automatically performed by the labeling system 100, and a user may be allowed to intervene in a label segment or labeling.
4) Clustering-based labeling: a method of assigning a label in a cluster unit after generating a plurality of clusters through grouping between similar data patterns by using a clustering scheme for time-series data. A label segment included in a cluster having a similar data pattern is assigned the same label. A label segment included in a cluster having a different data pattern is assigned a different label. FIG. 12 is an exemplary diagram in which the clustering-based labeling scheme has been applied.

As described above, the labeling system 100 may integrate and label time-series data by using various methods specialized for the time-series data. Specifically, the labeling system 100 may newly generate a label segment or assign a label to a previously generated label segment by applying the pattern matching, statistics, or clustering-based automatic labeling scheme.

The labeling system 100 may receive the meaning or related keyword of a label from a user through the user interface when the user designates the label, and may include the meaning or related keyword of the label in additional information of labeling result structuring information to be described later. Accordingly, the labeling system 100 can improve labeling accuracy performance of the classification model by using the labeling result structuring information, including the meaning or keyword of the label, as training data for the classification model. As another example, the labeling system 100 may include the name of an algorithm used in a similar pattern-based labeling, condition-based labeling, or clustering-based labeling process or similarity calculation, condition matching determination, or clustering results in additional information of labeling result structuring information, and can improve labeling accuracy performance of the classification model by using labeling result structuring information generated as described above as training data for the classification model.

### Structuring and Storage Format of Time-Series Labeling Results

The labeling system 100 according to an embodiment of the present disclosure generates data (hereinafter referred to as “labeling result structuring information”) having a standardized structure based on the assignment results of a label to time-series data, and stores the labeling result structuring information in the storage device 140. The labeling result structuring information includes a hierarchical tree structure in which the source, interpretation method, and filter condition of a label and the location of time-series data can be clearly described. The labeling system 100 may use the labeling result structuring information generated as described above to train the classification model by using the labeling result structuring information as training data for the classification model, and may use the labeling result structuring information when the results of labeling work are displayed to a user through the user interface after the labeling work is terminated. Multiple pieces of labeling result structuring information may be connected to one time-series datum or data extracted from the time-series datum. A user may construct training data by selecting or changing labeling result structuring information connected to time-series data based on utilization purposes for the time-series data and may train the classification model based on the constructed training data.

The labeling result structuring information basically includes source information of original data (i.e., source and access information of the original data) and label set information (i.e., the definition and labeling result information of a label). The labeling system 100 may obtain the source information in a process of collecting or receiving the original data, and may obtain the label set information based on preset data, data (e.g., filtering information or a label (or a label name)) input by a user, or information (e.g., a label (or a label name) or a label segment (i.e., a start time point and an end time point)) generated based on the original data in the labeling process.

For example, the labeling result structuring information may have hierarchical structures and items set in Tables 2 and 3. Table 2 indicates items and hierarchical structure of source information. Table 3 indicates items and hierarchical structure of label set information. As illustrated in Tables 2 and 3, the labeling result structuring information has the source information and the label set information as the highest layer. In Tables 2 and 3, lower information is included in each of the source information and the label set information. That is, information of a lower layer has a relation in which the information is included in information (corresponding to an ancestor node of a tree structure) of an upper layer thereof. For example, access information of a lower layer is included in source information that is a higher item thereof, and labeling result information thereof is included in label set information that is a higher item thereof.

TABLE 2

| | | higher | |
|---|---|---|---|
| | layer | item | |
| item | (Level) | (Patent) | Description |
| Source | 1 | No | Source and access |
| | | | information of original |
| | | | data (time-series data |
| | | | of original data) |
| Format | 2 | Source | Format (e.g., csv, |
| | | | influxDB, or Parquet) |
| | | | of data |
| Access information | 2 | Source | Information that |
| (contents) | | | identifies and accesses |
| | | | original data (content) |
| | | | based on a corresponding |
| | | | format (e.g., a path |
| | | | in the case of a |
| | | | file and a table name in |
| | | | the case of a DB) |
| Bucket name | 3 | Access | The name of a bucket in |
| (bucket_name) | | information | which data is stored |
| | | (contents) | (e.g., in the case of |
| | | | an influxDB) |
| Measurement target | 3 | Access | A measurement target |
| name | | information | table or collection name |
| (measurement_name) | | (contents) | (e.g., in the case of |
| | | | influxDB) |

TABLE 3

| | layer | higher item | |
|---|---|---|---|
| item | (Level) | (Patent) | Description |
| Label set | 1 | No | Label definition and |
| (label_set) | | | labeling result |
| | | | information (a plural |
| | | | number is possible) |
| Additional | 2 | Label set | Additional information |
| information | | (label_set) | of a label |
| (additional_info) | | | |
| Label list | 2 | Label set | a list of label values |
| (label_list) | | (label_set) | which may be used in |
| | | | corresponding analysis |
| | | | or work |
| Labeling results | 2 | Label set | A condition and |
| (label_result) | | (label_set) | segment of data to |
| | | | which a label has |
| | | | been assigned. |
| | | | That is, information on |
| | | | about how labels are |
| | | | assigned to data under |
| | | | which conditions the |
| | | | labels are actually |
| | | | assigned at what |
| | | | segment |
| Description of | 3 | Additional | A description of the |
| label | | information | meaning of a label |
| (label_description) | | (additional_info) | |
| Label-related | 3 | Additional | A Label-related |
| keyword | | information | keyword or an |
| (label_keywords) | | (additional_info) | algorithm used |
| Filtering | 3 | Labeling result | Information on a |
| information (filter) | | (label_result) | condition applied |
| | | | to the filtering of |
| | | | time-series data. |
| | | | The information may |
| | | | include feature |
| | | | information, tag |
| | | | information, and |
| | | | segment information |
| | | | of original data. |
| | | | The labeling system |
| | | | may extract only |
| | | | data to which a label |
| | | | has been assigned |
| | | | actually from |
| | | | original data |
| | | | (time-series data) |
| | | | based on filtering |
| | | | information. |
| Label | 3 | Labeling result | A label name, a time- |
| | | (label_result) | series segment |
| | | | (including a start |
| | | | time point and |
| | | | an end time point) |
| | | | corresponding to |
| | | | each label |
| Feature | 4 | Filter | The name of a time- |
| | | | series feature (i.e., |
| | | | an item of time-series |
| | | | data) that is an |
| | | | analysis target |
| Tag information | 4 | Filter | Information (e.g., a |
| (tag_info) | | | location or a region) |
| | | | that needs to be |
| | | | filtered under a |
| | | | condition, among |
| | | | complex time-series |
| | | | data |

Table 4 illustrates only the highest structure of labeling result structuring information. Source information and label set information, that is, items of a first layer (Level 1), are expressed in Table 4.

TABLE 4

{
“source”: { ... },
“label_set”: [ ... ]
}

In Table 4, the source information (source) includes format information (format) and access information (contents), and provides information on the source of various original data based on the format information and the access information.

In Table 4, the label set information (label_set) is information on label definition and labeling result, and a plurality of pieces of label set information may be present. Table 5 is the structure of label set information.

TABLE 5

“label_set”: [
{
“additional_info”: {...},
“label_list”: [...],
“label_result”: [...]
}
]

As illustrated in Table 5, the label set information (label_set) may include the additional information (additional_info), the label list (label_list), and the labeling result (label_result).

As illustrated in Table 3, the additional information (additional_info) includes the description of a label (label_description) and the label-related keyword (label_keywords). The description of the label (label_description) is a description of the meaning of a label. The label-related keyword (label_keywords) may include a keyword related to a label or an algorithm (e.g., similar pattern-based labeling, condition-based labeling, or clustering-based labeling) used in a labeling process.

The label list (label_list) refers to a list of label values available in labeling work. The labeling result (label_result) includes a condition and segment of data to which a label has been assigned.

Table 6 is an example of filtering information and label information included in label set information.

TABLE 6

{
“filter”: {
“feature”: [“INT_CO2”],
“tag_info”: {
“ZN_ID”: [“Zone_1”]
}
},
“label”: {
“Type1”: [
{“start”: “2021-07-01 00:00:00”, “end”: “2021-07-01 00:30:00”}
],
“Type2”: [
{“start”: “2021-07-01 01:50:00”, “end”: “2021-07-01 02:00:00”}
]
}
}

As proposed in Table 3, the feature (feature), among the filtering information (filter) included in the labeling result structuring information, indicates the name of a time-series data item (i.e., a feature) that is an analysis target. The tag information (tag_info) indicates information that needs to be filtered according to a condition, among time-series data that are complexly involved. Furthermore, the label information (label) included in the labeling result structuring information includes a specific label (refers to a label name), and information on the start time point and end time point of a label segment corresponding to the specific label.

From the filtering information in Table 6, it may be seen that filtering has been performed on an internal carbon dioxide concentration (INT_CO2) of a first zone (Zone_1), a label having Type 1 has been assigned to a label segment from 0:00 to 0:30 on Jul. 1, 2021, and a label having Type 2 has been assigned to a label segment from 1:50 to 2:00 on Jul. 1, 2021.

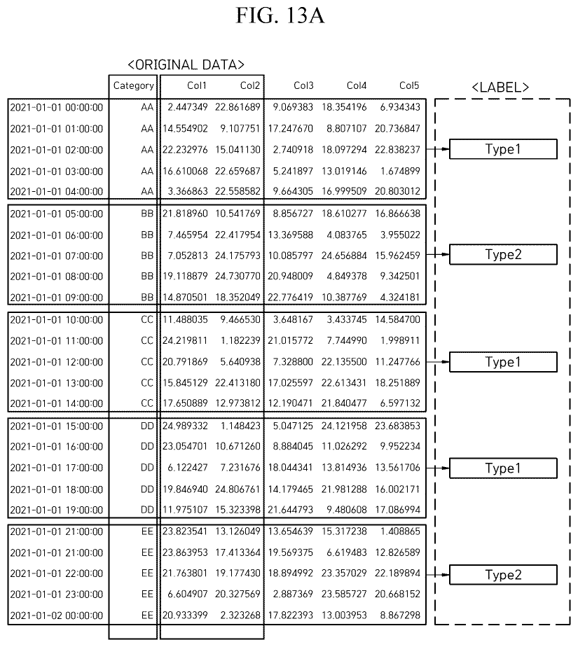

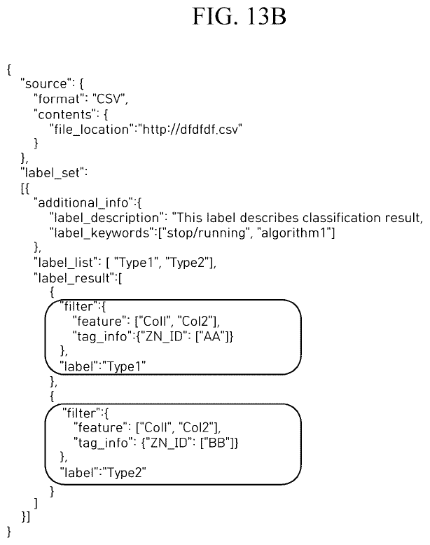

FIGS. 13A to 15B are views for describing the association of time-series data and labeling result structuring information.

FIGS. 13A and 13B are exemplary diagrams of labeling result structuring information that is generated when a label is assigned in a specific key value unit by using only a specific feature in original data. In the present examples, labels having Type1 and Type2 have been assigned to a specific zone (AA or BB) by using features Col1 and Col2.

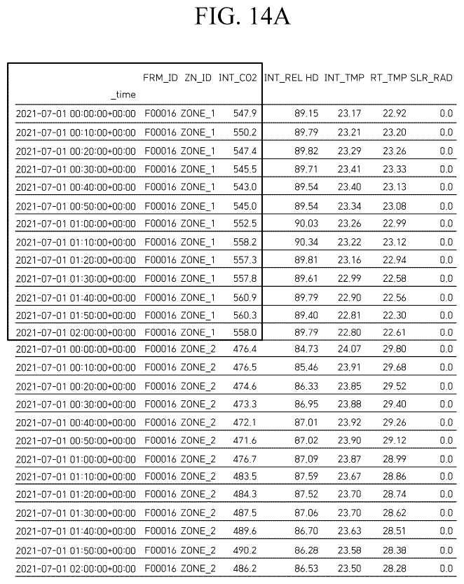

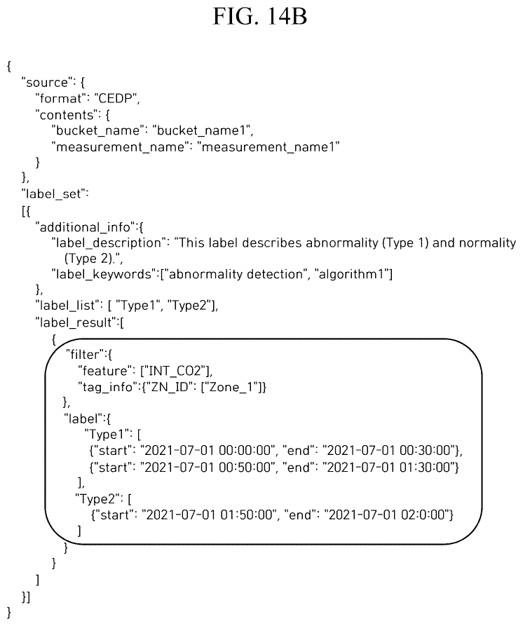

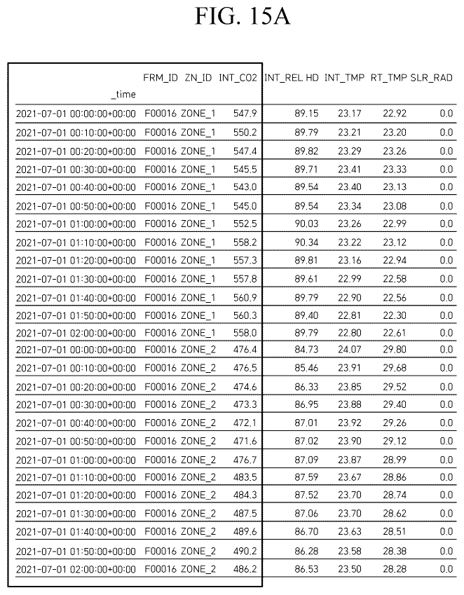

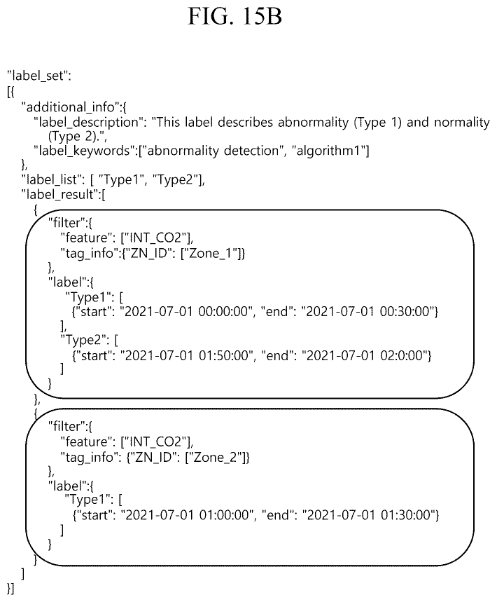

FIGS. 14A to 15B are exemplary diagrams of labeling result structuring information that is generated when all of features of original data are used and a label is assigned in a time unit based on specific key value data. For example, a label has been assigned to a specific zone (1 zone or 2 zone) in a designated time unit by using a feature INT_CO2.

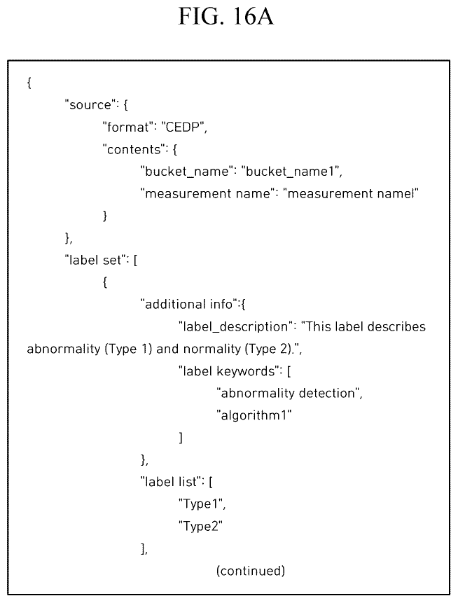

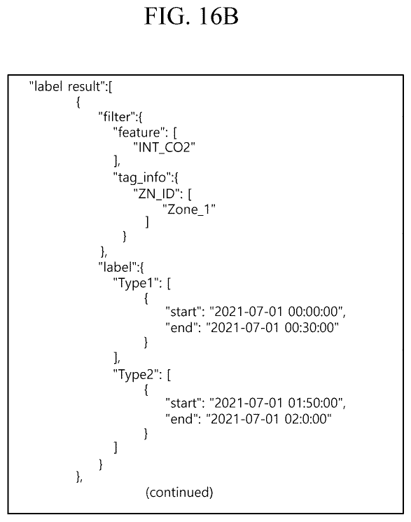

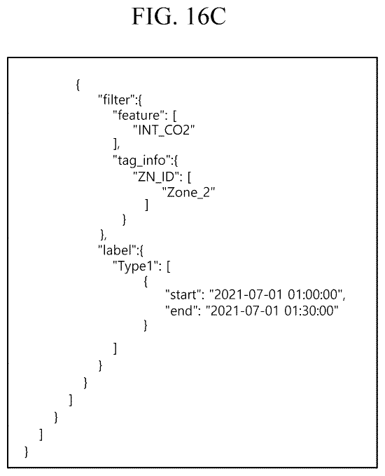

FIGS. 16A to 16C are exemplary diagrams of labeling result structuring information, and illustrate all of structures of labeling result structuring information.

A conventional technology has a limit to providing only simply independent time-series data and label information thereof. In contrast, labeling result structuring information generated by the labeling system 100 according to embodiments of the present disclosure has a standardized hierarchical structure, and includes a statistics scheme or the meaning and keyword (additional information) of a label, filtering information, and the location (an index or timestamp) or segment of time-series data along with the data source of original data. Accordingly, there is an advantage in that a user or classification model that is provided with the labeling result structuring information can recognize time-series data to which a label has been assigned suitably for purposes.

In short, in a conventional time-series data analysis method, time-series data and a label are independent present. In contrast, embodiments of the present disclosure have an advantage in that a connection between time-series data and labeling can be flexibly changed depending on utilization purposes of data based on labeling result structuring information which may be matched with the time-series data in a one-to-many way. Through such advantages, a user can stereoscopically understand labeling results and classification performance (i.e., labeling accuracy) of the classification model can be increased.

### Training of Classification Model

The labeling system 100 trains the classification model based on time-series data to which a label has been assigned. Specifically, the labeling system 100 may train the classification model by setting time-series data and labeling result structuring information as training data. For example, the classification model may use an LSTM and a transformer. In addition to a basic LSTM and a transformer model, a corresponding-series model or various models proposed based on the corresponding-series model may be used as the classification model that is used by the labeling system 100.

The labeling system 100 may check feedback from a user based on prediction confidence calculated by the classification model in a training process, and may incorporate the feedback into the training of the classification model (human-in-the-loop). For example, the labeling system 100 may request a user to check a data item (feature) of the classification model having low prediction confidence, and may exclude the corresponding data item (feature) from the training of the classification model based on the feedback from the user.

The labeling system 100 can consistently improve the classification model by introducing an adaptive training scheme. For example, the labeling system 100 can automatically retrain or fine-tune the classification model whenever a new label is added through labeling. That is, embodiments of the present disclosure propose a “time-series labeling pipeline structure” in which a semi-automatic path and an automatic path have been integrated based on a label.

Furthermore, the labeling system 100 may introduce semi-supervised training into the training of the classification model. For example, the labeling system 100 can adaptively improve the classification model based on feedback from a user by inputting a small amount of data to which a label has been assigned and original data (or division data) to which a pseudo label has been assigned to the classification model and requesting the check of the user based on prediction confidence calculated by the classification model.

### Additional Function and Interface

The user interface of the labeling system 100 may provide the following functions.
(1) A user can intuitively select a label segment because a time-series visualization-based drag interface is provided.
(2) A label version management and collaboration function: a label history can be managed for each user, and labels can be merged. This function has been conceived in that labels may be assigned to one time-series datum completely differently depending on different users and different time points, or different purposes.
(3) Highlighting and display of label uncertainty: a portion having low confidence in automatic prediction results using the classification model is visually highlighted. A user is allowed to manually modify the portion.
(4) Selection of an automatic recommendation-based labeling method: a time-series data division method, a labeling scheme, or the classification model that analyzes the existing log for labeling and that is frequently used by a user may recommend.

The configuration of the labeling system 100 according to embodiments of the present disclosure has the following advantages.
(1) It is possible to increase the description possibility and reproducibility of labeling in complex time-series data and to store labeling results as structured data.
(2) It provides a format (i.e., labeling result structuring information) on which an automation model can be trained by easily reading labeling results.
(3) It provides a consistent representation method of time-series data having various formats or sources.
(4) Effective collaboration is possible by allowing label confidence and a generation method to be shared between multiple users.

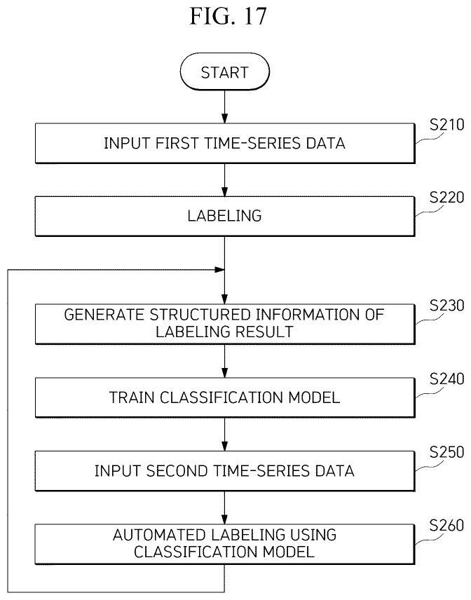

FIG. 17 is a flowchart for describing an operating method of the time-series data labeling system according to an embodiment of the present disclosure. The operating method may be performed by the labeling system 100, and may be performed by another piece of means. However, for description's convenience, hereinafter, an embodiment of the operating method that is performed by the labeling system 100 is described.

Referring to FIG. 17, the operating method of the time-series data labeling system according to an embodiment of the present disclosure includes steps S210 to S260.

The operating method of the time-series data labeling system illustrated in FIG. 17 is based on an embodiment. The steps of the operating method of the time-series data labeling system according to embodiments of the present disclosure are not limited to the embodiment illustrated in FIG. 17, and a step may be added, changed, or deleted if necessary.

Step S210 is a step of receiving first time-series data.

The processor 110 receives the first time-series data and source information of the first time-series data from the communication device 120, the memory 130, or the storage device 140.

Step S220 is a step of performing the labeling of the first time-series data.

The processor 110 sets a label segment, that is, a labeling target segment, in the first time-series data based on the input of a user, and performs the labeling of the first time-series data by assigning a label to the label segment.

The input of the user may include designating, by the processor 110, a data pattern that is used to extract candidate label segments from the first time-series data and selecting one or more label segments from the candidate label segments extracted by the processor 110 based on the data pattern.

Step S230 is a step of generating labeling result structuring information.

The processor 110 generates labeling result structuring information of the first time-series data based on the source information of the first time-series data and the results of the labeling of the first time-series data, and displays the labeling result structuring information of the first time-series data through the output interface device 160.

The labeling result structuring information of the first time-series data is hierarchically structured information as described above, and may include information that identifies and accesses the first time-series data and information on data items that are used in filtering in a process of labeling the first time-series data process. Likewise, such contents are also applied to the labeling result structuring information of the second time-series data.

Step S240 is a step of training the classification model.

The processor 110 trains the classification model, that is, an artificial intelligence model that performs the labeling of the time-series data, based on the first time-series data and the labeling result structuring information of the first time-series data.

The training of the classification model may include requesting feedback from a user when prediction confidence calculated by the classification model is lower than a threshold and fine-tuning the classification model based on the feedback from the user. In this case, the feedback may include excluding data having prediction confidence lower than the threshold, among the first time-series data, from training data for the training of the classification model.

Step S250 is a step of receiving second time-series data.

The processor 110 receives second time-series data and source information of the second time-series data from the communication device 120, the memory 130, or the storage device 140.

Step S260 is a step of performing the automatic labeling of the second time-series data by using the classification model.

The processor 110 performs the labeling of the second time-series data by using the trained classification model, and displays the results of the labeling of the second time-series data through the output interface device 160.

Thereafter, the labeling system 100 performs steps after step S230 on the second time-series data.

That is, the processor 110 generates labeling result structuring information of the second time-series data based on the source information of the second time-series data and the results of the labeling of the second time-series data, displays the labeling result structuring information of the second time-series data through the output interface device (S230), and retrains the classification model that has been previously trained by using the second time-series data and the labeling result structuring information of the second time-series data (S240).

Steps S250, S260, S230, S240, . . . after S250 may be repetitively performed by receiving other time-series data.

The operating method of the time-series data labeling system has been described with reference to the flowcharts presented in the drawings. For a simple description, the method has been illustrated and described as a series of blocks, but the present disclosure is not limited to the sequence of the blocks, and some blocks may be performed in a sequence different from or simultaneously with that of other blocks, which has been illustrated and described in this specification. Various other branches, flow paths, and sequences of blocks which achieve the same or similar results may be implemented. Furthermore, all the blocks illustrated in order to implement the method described in this specification may not be required.

In the description given with reference to FIG. 7, each of the steps may be further divided into additional steps or the steps may be combined into smaller steps depending on an implementation example of the present disclosure. Furthermore, some of the steps may be omitted, if necessary, and the sequence of the steps may be changed. Furthermore, the contents of FIGS. 1 to 16C, although some contents are omitted, may be applied to the contents of FIG. 7. Furthermore, the contents of FIG. 7 may be applied to the contents of FIGS. 1 to 16C.

As described above with reference to FIG. 1, the labeling system 100 according to an embodiment of the present disclosure may be implemented in the form of a computer system, but may also be implemented in the form of software or hardware, such as a field programmable gate array (FPGA) or an application specific integrated circuit (ASIC) unlike in FIG. 1.

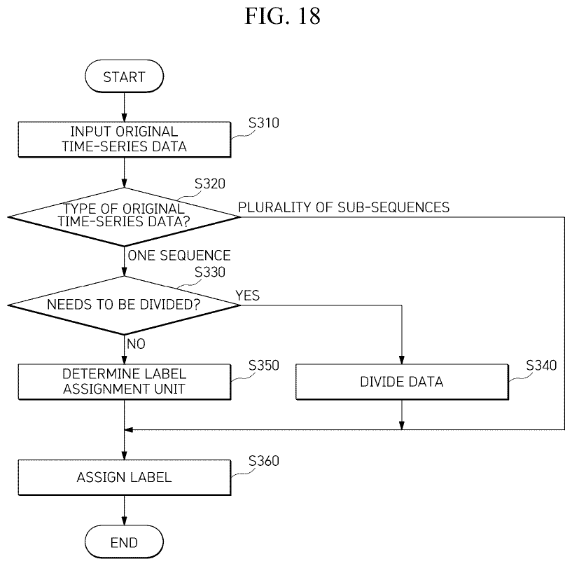

FIG. 18 is a flowchart for describing an operating method of the time-series data labeling system according to an embodiment of the present disclosure. The operating method of FIG. 18 includes a task for dividing time-series data or determining a label assignment unit.

Referring to FIG. 18, the operating method of the time-series data labeling system according to an embodiment of the present disclosure includes steps S310 to S360. The operating method illustrated in FIG. 18 is based on an embodiment, and a step may be added, changed, or deleted, if necessary.

It is presupposed that the time-series data labeling method illustrated in FIG. 18 is performed by the labeling system 100, for convenience of description.

Step S310 is a step of inputting original time-series data.

The labeling system 100 receives original time-series data from the storage device 140 or an external device, such as a database.

The original time-series data received by the labeling system 100 may be divided into three types as in Table 7.

TABLE 7
Type of original time-series data

| First type | One time-series data sequence |
|---|---|
| Second type | A set of a plurality of time-series data sub-sequences |
| | having the same length |
| Third type | A set of a plurality of time-series data sub-sequences |
| | having different lengths |

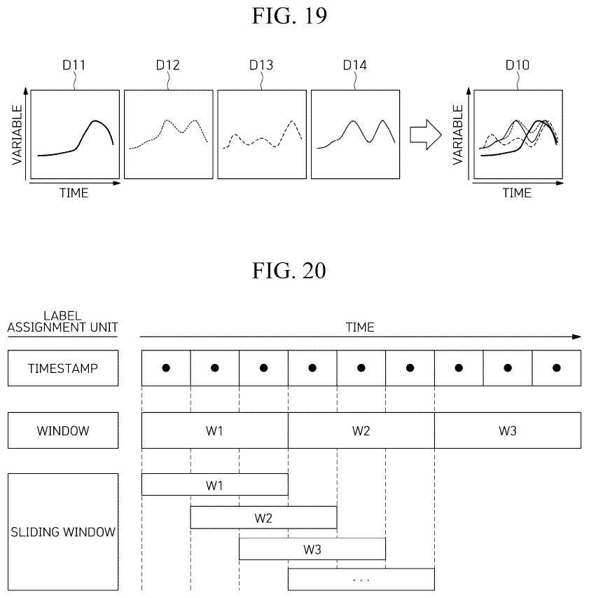

The first type is one time-series data sequence, and may be time-series data having a timestamp in a long term (e.g., 2 years). The second type is a plurality of time-series data sub-sequences having the same length (refer to FIG. 19). The third type is a plurality of time-series data sub-sequences having different lengths. For example, the first type of time-series data may be the concentration of fine dust in the air for two years. The second type of time-series data may be the results of the measurement of the step speeds of different subjects for 15 seconds. The third type of time-series data may be the trend of the heart rate while the subject is holding his breath (the time during which a subject holds his or her breath may vary each time).

Step S320 is a step that is branched depending on the type of original time-series data.

The labeling system 100 performs step S330 when the original time-series data corresponds to the first type, and performs step S360 when the original time-series data corresponds to the second type or the third type.

Step S330 is a step of determining whether the original time-series data needs to be divided.

The labeling system 100 determines whether the first type of original time-series data needs to be divided based on setting or a user input.

The labeling system 100 performs step S340 when the first type of original time-series data needs to be divided, and performs step S350 when the first type of original time-series data does not need to be divided.

Step S340 is a data division step.

The labeling system 100 segments the first type of original time-series data into the second type or the third type of time-series data based on setting or a user input.

The labeling system 100 may generate the second type of time-series data by dividing the first type of original time-series data into a periodical time unit. For example, the labeling system 100 may generate a plurality of sub-sequences (e.g., the second type of time-series data) by dividing time-series data (e.g., the first type of time-series data) for the years 2020 to 2022 by the day.

Furthermore, the labeling system 100 may generate the third type of time-series data by dividing the first type of original time-series data into different time units by using a segmentation function (SF). For example, the labeling system 100 may generate time-series data (e.g., the third type of time-series data) having different lengths by dividing time-series data (e.g., the first type of time-series data) relating to the heart rate of a person by using the segmentation function that generates a segment based on a change of variables. The segmentation function may be a rule-based function, and may be a function using an artificial intelligence model. For example, the labeling system 100 may use a timestamp as the reference of a segment by setting the corresponding timestamp as a changepoint when a difference between data predicted by long short-term memory (LSTM) and actual data included in the original time-series data is a threshold or more.

Step S350 is a step of determining a label assignment unit.

Step S350 is a step that is performed when the first type of original time-series data does not need to be divided. In this case, a label cannot be independently assigned based on a sub-sequence as in the second type or the third type. Instead, the labeling system 100 may determine a label assignment unit according to any one of three methods based on setting or a user input, and may assign a label to each label assignment unit (refer to FIG. 20).

The first method a method of determining a timestamp as a label assignment unit ((1-1)-th type). That is, the labeling system 100 may assign a label to each independent timestamp (i.e., one independent sample).

The second method is a method of determining a window as a label assignment unit ((1-2)-th type). That is, the labeling system 100 may set a window based on a predetermined window (time interval) size and assign a label to each window.

The third method is a method of determining a sliding window as a label assignment unit ((1-3)-th type). That is, the labeling system 100 may select data in a form in which a window has a predetermined size, but slides on the basis of one or more timestamp gaps, and may assign a label to the data. FIG. 20 illustrates an example in which one timestamp is set as the step gap of a sliding window. When a timestamp gap (i.e., the step gap of a sliding window) is identical with the size of a window in the (1-3)-th type, the (1-2)-th type may be considered as a special case of the (1-3)-th type because the (1-3)-th type becomes the same as the (1-2)-th type.

In general, the first method (the (1-1)-th type, a timestamp) is adopted as the label assignment method. However, if the label assignment method is used for the training of an artificial intelligence model, the second method (the (1-2)-th type, a window) or the third method (the (1-3)-th type, a sliding window) may be further required. Accordingly, the labeling system 100 needs to have a component capable of outputting such results.

Step S360 is a label assignment step.

The labeling system 100 assigns a label to the first type of time-series data based on the label assignment unit determined in step S350, and assigns one label to each sub-sequence in the case of the second type or third type of time-series data. That is, when a sub-sequence of time-series data is N, the labeling system 100 generally generates N labels and assigns the N labels to sub-sequences, respectively. For example, with respect to time-series data D10 of FIG. 19, the labeling system 100 may assign labels “A”, “B”, “C”, and “B” to sub-sequences D11, D12, D13, and D14, respectively.

Step S360 may be divided into a step S361 of determining a range in which a label is assigned and a step S362 of assigning a label.

First, step S361 of determining the range in which a label is assigned (may also be denoted as a “label assignment range” or a “label allocation range”) is described.

The labeling system 100 may provide a user interface so that a user can select a label allocation range and assign a label to the selected range. For example, the labeling system 100 may display time-series data, that is, a label assignment target, by visualizing the time-series data. A user may select the range (i.e., a label assignment range) of specific time-series data, among the visualized time-series data, and may input a label.

For example, with respect to the (1-1)-th type of time-series data, a user may select the range (i.e., a plurality of timestamps) of specific time-series data, among visualized time-series data, and may input a label. In this case, the same label may be assigned to all of lower stamps of the range selected by the user. Detailed contents of the method of assigning a label are described in step S362.

Furthermore, in the case of the (1-2)-th type or the (1-3)-th type, the labeling system 100 may determine all of windows including a range selected by a user as a label assignment range or determine all of windows including only some of the selected range as a label assignment range, depending on setting.

In the case of the second type or the third type, a user may select some of a plurality of sub-sequences, and may assign a label to the selected sub-sequence. In this case, the labeling system 100 may determine the sub-sequence selected by the user as a label assignment range.

Step S362 is a step of assigning a label to time-series data.

A user may manually select data to which a label will be assigned through an interface that is provided by the labeling system 100. The user may assign a label to all of data included in a label assignment range, and may select some data of a label assignment range as a sample and assign a label to data selected as the sample.

If the user selects some data included in the label assignment range as a sample and assigns a label to the corresponding data, the labeling system 100 detects data similar to the selected data in all of time-series data or a data assignment range through a similarity algorithm. The labeling system 100 may assign a label to a timestamp having a range to which any data similar to data selected as a sample belongs, a window that overlaps the range, or a window that fully overlaps the range. For example, the labeling system 100 may assign a label that has been assigned to sample data by a user, to a timestamp corresponding to data similar to data selected as a sample, or a window or sliding window including any some of similar data.

The labeling system 100 may classify a window or sub-sequence as any one of a plurality of features by using a clustering algorithm with respect to the (1-2)-th type, (1-3)-th type, second type, and third type of time-series data, and may assign a label to each classification result. Such an embodiment may not be applied to a timestamp unit (the (1-1)-th type).

Furthermore, in the case of the third type of time-series data, an algorithm that determines a dynamic length like dynamic time warping (DTW) may be used in similarity determination and classification because the lengths of sub-sequences may be different.

The labeling system 100 may automatically assign a label to a timestamp, a window, or a sub-sequence for which similarity has been determined or classification has been completed by using a label assignment function (or may be denoted as a “label allocation function”. In this case, a rule is necessary. When a label needs to be assigned to a window or a sub-sequence, a determination rule for each window or sub-sequence needs to be prepared. For example, if a label A is assigned to a value greater than 50, whether to assign a label to the (1-1)-th type of time-series data may be clearly determined. However, in the case of the (1-2)-th type, (1-3)-th type, second type, and third type of time-series data, a clear criterion or rule is required because several timestamps constitute a label assignment unit. Accordingly, the labeling system 100 applies a function that determines a representative value of a distribution of label assignment units and then determines which label will be assigned by using a label allocation function. For example, the representative value may be any one of the mean, mode, median, a maximum (max), or a minimum (min).

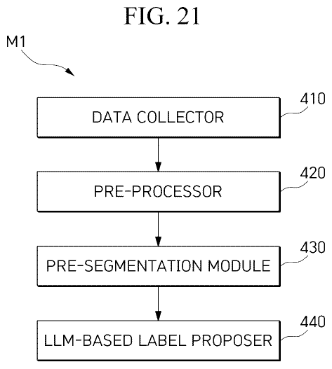

FIG. 21 is a block diagram illustrating the construction of a time-series data labeling module based on a large language model (LLM), which is mounted on the labeling system.

A time-series data labeling module M1 (hereinafter a “labeling module”) based on an LLM, which is illustrated in FIG. 21, includes a data collector 410, a preprocessor 420, a pre-segmentation module 430, and an LLM-based label proposer 440. The labeling system 100 may automatically assign a label to time-series data based on the LLM by driving the labeling module M1.

The processor 110 executes the labeling module M1 by executing one or more computer-readable instructions stored in the memory 130.

The data collector 410 collects time-series data from various sensors (e.g., a temperature sensor, a humidity sensor, a precipitation sensor, an insolation sensor, a soil moisture sensor, and a pest monitoring sensor). For example, the time-series data collected by the data collector 410 may include time information (timestamp), location information, a measurement unit, and a quality flag.

The preprocessor 420 pre-processes the time-series data collected by the data collector 410. For example, the preprocessor 420 performs the correction of a missing value, the removal of an outlier, and the unification of a unit. Furthermore, the preprocessor 420 may calculate the statistical feature values (e.g., the mean, a variance, a maximum/minimum, an accumulated amount, a moving average, a moving standard deviation, a trend factor, and a periodic index) of the time-series data for each preset segment.

The pre-segmentation module 430 is a module that divides the segment of time-series data based on the statistics of the time-series data. The pre-segmentation module 430 automatically detects a candidate label segment (may also be denoted as a “segment candidate”) having a good possibility that an event will occur by analyzing large time-series data according to a predetermined rule. The pre-segmentation module 430 performs a data windowing (data division) function, a feature value calculation function, a candidate label segment (segment candidate) detection function, and a metadata generation function for a candidate label segment.

Hereinafter, on the premise that the labeling system 100 is applied to the field of climate and agriculture, the functions of the pre-segmentation module 430 are described. However, the labeling system 100 according to an embodiment of the present disclosure may also be applied to other fields.

### Data Windowing

First, the pre-segmentation module 430 performs the data windowing function. Data windowing is a scheme that processes some of large time-series data by dividing some of the large time-series data into windows each having a predetermined size. That is, the pre-segmentation module 430 divides time-series data based on a window size and a step gap that are set by a user or designated according to a mode (e.g., a basic mode or a detailed detection mode).

The pre-segmentation module 430 may divide time-series data in a time interval unit by applying a sliding window scheme. In this case, the window size and the step gap may be automatically set by the labeling system and may be adjusted by a user. The pre-segmentation module 430 may divide data by applying any one of 1) the basic mode and 2) the detailed detection mode.
1) The basic mode: in the basic mode, the pre-segmentation module 430 generates an event unit that is simple and easy to understand by dividing time-series data at predetermined intervals (e.g., a 3-day unit or a 7-day unit) in a non-overlapping way (corresponding to the “window” in FIG. 20). That is, in the basic mode, the label assignment unit is the window. A time interval that is generated as described above has an advantage in that amateurs (e.g., farmers and local government officers) that directly handle data in agricultural sites can easily interpret the data.
2) The detailed detection mode: when a sudden change in climate variables is detected or the LLM-based label proposer 440 points out “boundary ambiguity”, the pre-segmentation module 430 switches to the detailed detection mode and performs data windowing (corresponding to the “sliding window” in FIG. 20) in an overlap window way. That is, in the detailed detection mode, the label assignment unit is the sliding window. For example, when a sudden change in climate variables is detected or the LLM-based label proposer 440 mentions “boundary ambiguity”, the pre-segmentation module 430 sets a window as 5 days and sets the step size as 2 days. A time interval that is generated as described above has advantages in that in the labeling of time-series data, a detailed change can be incorporated and the start point and end point of an actual event can be detected more accurately.

### Calculation of Feature Value

Next, the feature value calculation function of the pre-segmentation module 430 is described. The pre-segmentation module 430 may calculate the feature values of time intervals generated through data windowing and store the feature values in the storage device 140. The following is an example of quantitative indices (feature metrics) which may become the feature values.
(1) Basic statistics index: the mean, a maximum, a minimum, a standard deviation, a variance, and a central value
(2) Trend index: a moving average (EMA), a linear regression slope, a daily increase/decrease rate, and seasonal indices (ACF and PACF)
(3) Accumulation index: accumulated precipitation, the number of days without continuous precipitation, and the number of days with continuous lack of soil moisture
(4) Comparison index: an average for the past period (climatology mean), a percentile, and a z-score
(5) Category index: A categorized feature label, such as very low, low, moderate, high, or very high, is generated by comparing a calculated value and a domain threshold.

### Detection of Candidate Label Segment (Segment Candidate)

The pre-segmentation module 430 detects a candidate label segment by applying a changepoint detection algorithm based on the feature values of time-series data for each time interval. The candidate label segment is an event segment which may be a label assignment target. For example, the pre-segmentation module 430 may detect a point at which a distribution characteristic is suddenly changed (i.e., a changepoint) in time-series data based on the calculated feature values, and may designate a candidate label segment on the basis of the point.

Examples of the changepoint detection algorithm which may be used for the pre-segmentation module 430 to detect the candidate label segment include a cumulative SUM (CUSUM), a pruned exact linear time (PELT), Bayesian changepoint detection, and dynamic programming-based segmentation scheme.

The changepoint detected by the pre-segmentation module 430 is set as the potential start point and end point of the candidate label segment. A specific timestamp may become the changepoint. The start point or end point of a specific time interval may become the changepoint.

For example, the pre-segmentation module 430 may select a segment that satisfies whether statistical standards are satisfied (e.g., soil moisture is 20% or less for 5 consecutive days) as the candidate label segment.

### Generation of Metadata for Candidate Label Segment

The pre-segmentation module 430 derives a candidate label segment from time-series data through a data windowing step, a feature value calculation step, and a candidate label segment detection step. The pre-segmentation module 430 generates metadata that includes summary information of candidate label segment, that is, a target, and that has a standardized structure (schema) (hereinafter “metadata”) based on the results of the execution of data windowing, feature value calculation, and candidate label segment detection, and stores the metadata in the storage device 140. That is, the pre-segmentation module 430 generates and stores the metadata of a candidate label segment based on the time interval of time-series data, the feature value of each time interval, and a changepoint. The stored metadata is used by the LLM-based label proposer 440.

The metadata may include a unique identifier of a candidate label segment, a time range, a changepoint, a feature value, information compared to the normal year (or information compared to a reference), the semantic category of an index, a quality evaluation index (a quality flag or a quality flag), LLM input and output assistance information, and sensitive information to be excluded from a labeling target. The information compared to the normal year (reference) includes a ratio compared to a baseline. The pre-segmentation module 430 may use a known statistical scheme or LLM in generating the metadata of a candidate label segment.

For example, the pre-segmentation module 430 may also include a ratio of missing values of time-series data, a ratio of outliers, and the validity of data included in a candidate label segment in the quality flag in addition to goodness-of-fit (fit), separation (sep), the length of region (len_reg), changepoint agreement (cp_agree), and coverage.

An object of structuring metadata is as follows.
(1) To secure interoperability with an LLM by including a temporal boundary, statistical characteristics, interpretation compared to a reference, and quality flag of each candidate label segment in a consistent schema
(2) To reduce a budget necessary for the token input of the LLM by summarizing and compressing data
(3) To secure traceability for auditing or reproduction by recording a source and a pre-processing history

The following is an example of the schema of metadata that is generated by the pre-segmentation module 430. The following metadata has been structuralized based on JavaScript object notation (JSON). In the metadata, an essential field and an optional field are clearly divided. In the schema of the metadata, a segment-unique identifier (segment_id) corresponds to a specific candidate label segment. The example of the following schema may be extended according to an embodiment of the present disclosure.

EXAMPLE OF SCHEMA OF METADATA

```
{
  “segment_id”: “string”, // segment-unique identifier
  “time_window”: { // interval time range
  “start”: “YYYY-MM-DD”,
  “end”: “YYYY-MM-DD”
  },
  “change_points”: [ // major changepoints at which segments are formed
  {“ts”:“YYYY-MM-DD”, “method”:“PELT”, “score”:0.87}
  ],
  “features”: { // major numerical value indices within segment
  “temp_c”: {“mean”: 35.0, “max”: 39.1, “std”: 2.4, “unit”: “°C”},
  “precip_mm”: {“sum”: 2.0, “unit”: “mm”},
  “soil_moisture_pct”: {“mean”: 15.1, “unit”: “%”}
  },
  “baselines”: { // information compared to normal year/reference
  “temp_c”: {“climo_mean”: 30.0, “z”: 2.1, “percentile”: 0.92},
  “precip_mm”:{“climo_mean”: 40.0, “z”: −2.3, “percentile”: 0.04}
  },
  “category_encoding”: { // semantic category of each index (multi-allocation possible)
  “temp_c”: [
    {“type”:“percentile”,“level”:“very_high”},
    {“type”:“rule_based”, “rule_id”:“heatwave_v1”, “level”:“heat_stress”}
  ],
  “precip_mm”: [{“type”:“percentile”, “level”:“very_low”}],
  “soil_moisture_pct”: [{“type”:“rule_based”, “rule_id”:“soil_dry_v1”, “level”:“very_low”}]
  },
  “quality”: { // segment quality evaluation index (quality flag, quality flag)
  “fit”:0.81, “sep”:0.77, “len_reg”:0.05,
  “cp_agree”:0.66, “coverage”:0.98,
  “overall”:0.83, “uncertainty”:0.17
  },
  “llm_io_hint”: { // LLM input/output assistance information
  “compression_level”:“compact”, // compact | verbose
  “include_fields”:[“time_window”, “features”, “baselines”, “category_encoding”],
  “exclude_fields”:[“series_id”], // sensitive information excluded
  “value_formats”:{“temp_c”:{“round”:1}, “precip_mm”:{“round”:1}},
  “natural_language_summary”:
  “7/1~7/10 average temperature 35.0°C (normal year+5°C, very high), precipitation 2.0 mm
(very low compared to normal year 40.0 mm), soil moisture 15% or continue”
  }
}
```

The pre-segmentation module 430 induces an LLM to perform inference based on interpretation (e.g., heat waves and droughts) based on domain knowledge in addition to simple numerical values by representing a core index and semantic category for each segment as a multi-layer structure through structuralized metadata as illustrated in the example.

Furthermore, the LLM-based label proposer 440 or the LLM may automatically filter a candidate label segment having a low synthesis index (overall) or low uncertainty included in a quality flag included in metadata or may first propose the candidate label segment as a user review target.

Furthermore, the LLM-based label proposer 440 may efficiently control the size of a token that is included in metadata and that is input to the LLM. The input/output assistance information includes a natural language summary (natural_language_summary). For example, the pre-segmentation module 430 may generate a natural language summary through a natural language processing scheme or the LLM based on feature values and previously collected normal year values (or reference values). The natural language summary included in the metadata may become understanding data that is intuitive to a user that is an amateur.

Hereinafter, the functions of the LLM-based label proposer 440 are described. As in the pre-segmentation module 430, an embodiment in which the LLM-based label proposer 440 is applied to the field of climate and agriculture is described.

The LLM-based label proposer 440 automatically generates a semantic event label based on natural language explanatory notes, and proposes the generated semantic event label to a user through the output interface device 160.

The LLM-based label proposer 440 generates natural language explanatory notes by using an LLM by receiving metadata generated by the pre-segmentation module 430, domain ontology data and/or user feedback, and automatically proposes a semantic event label based on the natural language explanatory notes. The LLM-based label proposer 440 converts simple numerical value information in a form in which the simple numerical value information may be interpreted by a person by using an LLM, and may correspond a candidate label segment to an existing defined event type in association with domain ontology or perform all of functions that propose an open label, that is, a new event.

For example, the LLM-based label proposer 440 generates natural language explanatory notes based on metadata corresponding to a specific candidate label segment, extracts a plurality of keywords from the natural language explanatory notes, and compares the plurality of keywords with domain ontology data corresponding to a set field. The LLM-based label proposer 440 may simultaneously set new open labels that are proposed by an LLM as the event label of a candidate label segment based on ontology data matched with a keyword or a keyword not matched with the ontology data.

### Input Data

The following is data (input data) input to LLM-based label proposer 440.
(1) Metadata: the metadata of a candidate label segment that is generated by the pre-segmentation module 430. The metadata includes a time interval (or a time range), a changepoint, major statistics, the normal year value or a value (e.g., a percentile) compared to a reference value, a category, a quality score, and LLM input/output assistance information (refer to the example of the metadata schema)
(2) Domain ontology data: an event (e.g., heat waves, cold waters, droughts, and pests and diseases) specialized and defined for an agricultural cultivation environment, a condition rule for each event, and thesaurus
(3) User feedback record: a user approval or denial history that is input in a step of training a previous classification model (or a labeling model) or correcting a label segment or a label

### Generation of Natural Language Explanatory Notes

The LLM-based label proposer 440 may generate natural language explanatory notes by interpreting quantitative data (e.g., a feature value and a baseline item (information compared to the normal year or reference)) included in metadata. For example, the LLM-based label proposer 440 may generate the explanatory notes of a candidate label segment by linguistically summarizing a difference compared to the normal year, a degree of outliers, and duration of major data items on the basis of a feature value and a baseline item for each candidate label segment. As a detailed example, when the mean temperature (temp_c.mean) included in metadata is 35.2° C., the normal year value (climo_mean) is 30° C., a z value is +2.1, and duration (may be determined as a time range) is 10 days, the LLM-based label proposer 440 may generate natural language explanatory notes reading that a “heat wave pattern in which the mean temperature is about 5° C. higher than the normal year and lasts for 10 days” corresponding to a corresponding candidate label segment.

Furthermore, the LLM-based label proposer 440 may generate explanatory notes based on category information. For example, when a semantic category (category_encoding) field included in metadata is

“temp_c”:[{“type”: “percentile”, “level”: “very_high”},
{“type”:“rule_based”, “level”: “heat_stress”}],

the LLM-based label proposer 440 may generate natural language explanatory notes reading that “a temperature is very high, that is, 10% or more of the normal year, and a “heat stress situation” in terms of crop growth.

Furthermore, the LLM-based label proposer 440 may generate natural language explanatory notes by using LLM input/output assistance information (Ilm_io_hint) included in metadata.

For example, the LLM-based label proposer 440 may generate natural language explanatory notes based on a natural language summary (natural_language_summary) included in the input/output assistance information (Ilm_io_hint) (a natural language summary may be used without any change and an LLM may generate natural language explanatory notes based on the natural language summary), and may enable an LLM to directly generate the natural language explanatory notes by inputting the metadata to the LLM.

The natural language explanatory notes generated by the LLM-based label proposer 440 through the aforementioned method may be displayed in a corresponding candidate label segment in time-series data through the output interface device 160. In this case, there is an advantage in that even amateurs can intuitively understand the meaning of time-series data.

### Inference of Event Label

First, the LLM-based label proposer 440 may infer the event label of a candidate label segment through an ontology mapping scheme. The LLM-based label proposer 440 may extract a keyword from natural language explanatory notes generated through the aforementioned method, may set data having the highest similarity with the extracted keyword, among previously input domain ontology data, as an event label corresponding to a corresponding candidate label segment by comparing the extracted keyword with previously input domain ontology data, and may display the set data through the output interface device 160.

For example, it is assumed that domain ontology data has been constructed to have a tree structure. If a keyword extracted from natural language explanatory notes is “heat waves”, the LLM-based label proposer 440 may search the domain ontology data constructed like “climate disaster (level 1)>temperature (level 2)>high temperature (level 3)>heat waves (level 4)” for the most similar “heat waves”, and may set and display the “heat waves” as the event label of a candidate label segment.

If an event label cannot be determined (e.g., if domain ontology data that is matched with the extracted keyword or has similarity with the extracted keyword by a threshold or more cannot be found) through ontology mapping, the LLM-based label proposer 440 may extend ontology by proposing an open-label event. That is, the LLM-based label proposer 440 proposes a data pattern that is not present in the existing ontology as a “new event” by using an LLM. When a user approves the proposed event, the corresponding event is automatically registered with the domain ontology data, and thus the domain ontology is extended.

For example, when a keyword extracted from natural language explanatory notes is not matched with domain ontology data, the LLM-based label proposer 440 may determine a corresponding candidate label segment (or metadata) as a new event candidate. As a detailed example, it is assumed that natural language explanatory notes corresponding to a candidate label segment is “crop stress occurs because a day and night daily temperature range is great”. When data similar to a keyword extracted from the natural language explanatory notes is not present in domain ontology, the LLM-based label proposer 440 may determine a “daily temperature range stress”, that is, an event label determined by inputting the natural language explanatory notes to an LLM, as a new event label candidate (open_label_candidate), and may add the new event label candidate to the domain ontology data through the approval of a user.

### Calculation of Label Confidence

The LLM-based label proposer 440 may calculate confidence for each extracted event label as described above by using an LLM. For example, when an event level collides with the existing rule matching (rule_matches) results, low confidence is assigned to the event level because the even level has high uncertainty. When the mean, a central value, or a maximum of confidence calculated with respect to a plurality of event labels is less than a threshold, the LLM-based label proposer 440 determines the “boundary ambiguity” of a candidate label segment by inputting metadata to an LLM. When determining that the “boundary ambiguity” is present, the pre-segmentation module 430 may switch into the data windowing mode. For example, when determining that the “boundary ambiguity” is present, the pre-segmentation module 430 may switch into the detailed detection mode the size of the window and the step gap of which have been reduced compared to the basic mode.

The following is an example of the definition of a schema (denoted as event label structuring information or an event label schema) for an event label generated by the LLM-based label proposer 440. Like the metadata, the event label may be structuralized according to the JSON-based schema.

EXAMPLE OF EVENT LABEL SCHEMA (DEFINITION)

```
{
  “segment_id”: “string”, // reference segment ID
  “description”: “string”, // natural language explanatory notes generated by LLM
  “labels”: [// a list of proposed event labels
  {
    “name”: “heat waves”,
    “ontology_path”: [“climate disaster”, “temperature”, “high temperature”, “heat waves”],
    “confidence”: 0.87, // confidence
    “evidence”: [“the mean temperature 35°C”, “+5°C compared to the normal year”, “lasting
10 days in a row”]
  },
  {
    “name”: “drought”,
    “ontology_path”: [“climate disaster”, “water resources”, “drought”],
    “confidence”: 0.72,
    “evidence”: [“precipitation 2 mm”, “−95%” compared to the normal year]
  }
  ],
  “open_label_candidates”: [ // proposes a new event (event label)
  {
    “name”: “daily temperature range stress”,
    “confidence”: 0.55,
    “reason”: “day/night temperature difference is great, and a crop stress symptom
monitored”
  }
  ]
}
```

The following is an example of an event label schema for the agricultural field.

EXAMPLE OF EVENT LABEL SCHEMA FOR AGRICULTURAL FIELD

```
{
  “segment_id”: “seg_20240701_20240710”,
  “description”: “There is a good possibility that drag and crop stress may occur because the
mean temperature was 35°C, which was 5°C higher than the normal year, a high temperature
continued for 10 consecutive days, and the precipitation was only 2 mm from July 1 to 10,
2024.”,
  “labels”: [
  {
    “name”: “heat waves”,
    “ontology_path”: [“agricultural environment”, “climate disaster”, “temperature”, “heat
waves”],
    “confidence”: 0.88,
    “evidence”: [“mean temperature 35°C”, “normal year+5°C”, “lasting 10 days in a row”]
  },
  {
    “name”: “drought”,
    “ontology_path”: [“agricultural environment”, “climate disaster”, “water resources”,
“drought”],
    “confidence”: 0.72,
    “evidence”: [“precipitation 2 mm”, “very low compared to normal year 40 mm “, “maintain
soil moisture 15% or less “]
  }
  ],
  “open_label_candidates”: [
  {
    “name”: “daily temperature range stress”,
    “confidence”: 0.55,
    “reason”: “day highest 39°C, night lowest 20°C and daily temperature range is 15°C or
more”
  }
  ]
}
```

The functions of the LLM-based label proposer 440 have been described above. The LLM-based label proposer 440 automatically generates natural language explanatory notes which may be understood by even amateurs based on quantitative data included in metadata so that time-series data can be immediately used in sites.

Furthermore, the LLM-based label proposer 440 may propose a new event type (open-label) by using the semantic inference of an LLM while maintaining compatibility with the existing rule-based labeling system through ontology mapping. The newly proposed event label (open-label) is registered with an event label schema as “open_label_candidates”. “open_label_candidates” may be added to domain ontology data through the approval of a user. The labeling system 100 can continuously develop a domain knowledge system.

Furthermore, the LLM-based label proposer 440 calculates confidence for each event label by using an LLM, includes the confidence in an event label schema, and displays the event label and the confidence together. Accordingly, a user can intuitively determine the suitability of the event label and provide feedback therefor, if necessary. Accordingly, the LLM that is used by the LLM the labeling system 100 or the classification model that is mounted on the labeling system 100 may be trained based on the user feedback.

Hereinafter, an embodiment in which the labeling system 100 is applied to the labeling of time-series data relating to crop cultivation is described.

### 1. Outline of Embodiment

The present embodiment is a detailed example in which the time-series data labeling system 100 according to an embodiment of the present disclosure is applied by being associated with a crop cultivation environment monitoring system. The labeling system 100 immediately provides a natural language description and an event label which may be easily understood by farmers and researchers by analyzing time-series data, such as temperatures, precipitation, soil moisture, and insolation collected in crop cultivation sites.

### 2. Scenario: Detection of Heat Waves or Drought Caused by the Lack of Rain in the Summer

### 2.1 Data Collection and Pre-Processing

In this scenario, the source of time-series data is Smart Farm house (field A, greenhouse1) in Jeonju-si, Jeonbuk, Korea. Various sensors have been installed in the Smart Farm. Time-series data items collected by the sensors are as follows.
(1) Air temperature (° C.): measured by the hour by using an air temperature sensor
(2) Soil moisture (%): measured by using a soil moisture sensor
(3) Precipitation (mm): measured by a rain gauge
(4) Period: Jun. 15-20, 2024
   Furthermore, the following is a pre-processing process for the time-series data.
(1) Correction by linear interpolation when sensor data is omitted
(2) Erroneous data (99° C. record) on June 28 is detected as an outlier and removed
(3) The unit of each datum is standardized (° C., %, mm)

### 2.2 Statistics-Based Segment

(1) The basic mode: a basic window and a step gap were set as 7 days, and a non-overlapping segment of a 7-day unit was generated
(2) The detailed detection mode: a window size and a step gap were set so that a sudden change in the short period was reflected by applying 3 days to the window size and 2 days to the step gap
(3) Results of detection of changepoint
   a. On July 1, the mean temperature was 5° C. higher than that of the normal year (PELT detected, score=8.7)
   b. On July 10, a pattern change was detected due to the recovery of precipitation (CUSUM detected, score=7.9)

The following is an example of metadata that was generated during a candidate label segment (time range) from Jun. 1-10, 2024 according to the present scenario.

EXAMPLE OF METADATA EXTRACTED FROM TIME-
SERIES DATA IN AGRICULTURAL FIELD

```
{
  “segment_id”: “seg_20240701_20240710”,
  “series_id”: “fieldA_greenhouse1”,
  “time_window”: {
  “start”: “2024-07-01”,
  “end”: “2024-07-10”,
  “tz”: “Asia/Seoul”,
  “inclusive”: {“start”: true, “end”: true}
  },
  “change_points”: [
  {“ts”: “2024-07-01”, “method”: “PELT”, “scale”: “W5S2”, “score”: 0.87},
  {“ts”: “2024-07-10”, “method”: “CUSUM”, “scale”: “W3S3”, “score”: 0.79}
  ],
  “features”: {
  “temp_c”: {“mean”: 35.2, “max”: 39.1, “std”: 2.4, “unit”: “°C”},
  “precip_mm”: {“sum”: 2.0, “unit”: “mm”},
  “soil_moisture_pct”: {“mean”: 15.1, “unit”: “%”}
  },
  “baselines”: {
  “temp_c”: {“climo_mean”: 30.0, “z”: 2.1, “percentile”: 0.92},
  “precip_mm”: {“climo_mean”: 40.0, “z”: −2.3, “percentile”: 0.04}
  },
  “category_encoding”: {
  “temp_c”: [
    {“type”: “percentile”, “level”: “very_high”},
    {“type”: “rule_based”, “rule_id”: “heatwave_v1”, “level”: “heat_stress”}
  ],
  “precip_mm”: [
    {“type”: “percentile”, “level”: “very_low”},
    {“type”: “climatology”, “interpretation”: “drought_condition”}
  ],
  “soil_moisture_pct”: [
    {“type”: “rule_based”, “rule_id”: “soil_dry_v1”, “level”: “very_low”}
  ]
  },
  “quality”: {
  “fit”: 0.81,
  “sep”: 0.77,
  “len_reg”: 0.05,
  “cp_agree”: 0.66,
  “coverage”: 0.98,
  “overall”: 0.83,
  “uncertainty”: 0.17
  },
  “provenance”: {
  “sensor_ids”: [“S-TO-001”, “S-RF-004”],
  “preprocess”: {“version”: “1.3.2”, “hash”: “ba7e..”},
  “calibration”: {“temp_c”: “2025-05-01”, “precip_mm”: “2025-06-12”}
  },
  “llm_io_hint”: {
  “compression_level”: “compact”,
  “include_fields”: [“time_window”, “features”, “baselines”, “category_encoding”,
“rule_matches”],
  “exclude_fields”: [“series_id”],
  “value_formats”: {“temp_c”: {“round”: 1}, “precip_mm”: {“round”: 1}},
  “natural_language_summary”:
    “an average temperature 35.0°C (normal year+5°C, very high), precipitation 2.0 mm (very
low compared to the normal year 40.0 mm), and soil moisture 15% or less continues from July
1 to 10, 2024 → possible heat waves and drought.”
  }
}
```

In the present embodiment, the LLM-based label proposer 440 of the labeling system 100 automatically wrote natural language explanatory notes, such as “In early July, a temperature was higher than that in the normal year and there was little precipitation, resulting in drought and heat wave conditions” by using an LLM based on the metadata.

Furthermore, the LLM-based label proposer 440 proposed domain event labels, such as “heat waves” and “drought”, through a semantic labeling process of applying domain ontology data-based rule matching (rule_matches) to the semantic category (category_encoding) field of the metadata.

Furthermore, the LLM-based label proposer 440 recorded a new event candidate (open-label candidate), such as “daily temperature range stress”, which is not present in domain ontology, on “open_label_candidates” of the event label schema based on the natural language explanatory notes generated based on the metadata.

Furthermore, as a confidence-based feedback process, the LLM-based label proposer 440 automatically selects and displays a candidate label segment to be reviewed by a person by using a quality flag (e.g., quality.overall, quality.uncertainty) included in the metadata so that a user (a farmer or a policy officer) can check the candidate label segment.

A farmer or a policy officer who is an amateur may check the time-series data of a candidate label segment, metadata, and an event label, that is, review targets, through the output interface device 160, and may easily correct the time range of a corresponding candidate label segment, a changepoint, and an event label.

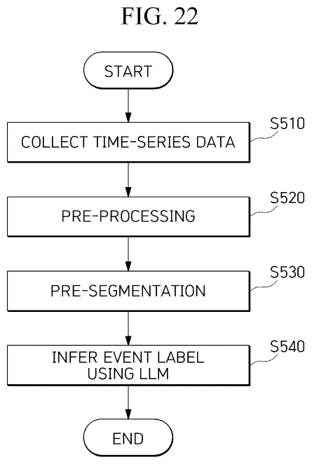

FIG. 22 is a flowchart for describing an operating method of the time-series data labeling system according to an embodiment of the present disclosure. The method of FIG. 22 may be executed by the labeling system 100.

Referring to FIG. 22, the operating method of the time-series data labeling system 100 according to an embodiment of the present disclosure includes steps S510 to S540. The operating method of the labeling system 100 illustrated in FIG. 22 is based on an embodiment, and a step may be added, changed, or deleted, if necessary.

Steps S510 to S540 in FIG. 22 correspond to 410 to 440 in FIG. 21, respectively. That is, step S510 is performed by the data collector 410, step S520 is performed by the preprocessor 420, step S530 is performed by the pre-segmentation module 430, and step S540 is performed by the LLM-based label proposer 440. Accordingly, detailed contents of the steps in FIG. 22 may be understood based on the contents described with reference to FIG. 21, and thus detailed descriptions of the steps in FIG. 22 are omitted.

Step S510 is a step of collecting the time-series data of a specific domain.

The labeling system 100 collects the time-series data of a specific domain (e.g., an agricultural field). The time-series data may be multi-modal data. For example, the time-series data may include an image, a video, and sound data in addition to sensor data. However, an image, a video, and sound data may require texturing pre-processing.

Step S520 is a pre-processing step.

The labeling system 100 performs pre-processing on the collected time-series data, such as the correction of a missing value, the removal of an outlier, the unification of a unit, and text conversion.

Step S530 is a pre-segmentation step.

The labeling system 100 segments the time-series data into one or more time intervals based on a predetermined window size and step gap. Furthermore, the labeling system 100 determines a candidate label segment by applying the changepoint detection algorithm to the feature values of the divided time intervals. Furthermore, the labeling system 100 generates metadata, that is, structuralized summary information corresponding to the candidate label segment based on the time-series data of the candidate label segment.

Step S540 is a step of inferring an event label by using an LLM.

The labeling system 100 generates natural language explanatory notes by inputting the metadata or some information extracted from the metadata to the LLM. Furthermore, the labeling system 100 generates an event label corresponding to the candidate label segment by using the LLM based on the natural language explanatory notes or a keyword extracted from the natural language explanatory notes.

Although not illustrated in FIG. 22, the operating method of FIG. 22 may further include a step of outputting data corresponding to the candidate label segment and the event label through the output interface device so that a user can check the candidate label segment and the event label and a step of modifying the metadata or the event label based on feedback from a user, after step S540. The labeling system 100 may display all of data that is collected or generated through steps S510 to S540 through the output interface device 160 or may transmit the all of the data to the terminal of a user through the communication device 120 in order to help understanding of the user. Furthermore, the labeling system 100 may modify the time-series data or data (e.g., the metadata and the event label) generated based on the time-series data by receiving feedback from a user, may train the classification model (or the labeling model) mounted on the labeling system 100, or may fine-tune the LLM.

The operating method of the labeling system 100 has been described with reference to the flowcharts presented in the drawings. For a simple description, the method has been illustrated and described as a series of blocks, but the present disclosure is not limited to the sequence of the blocks, and some blocks may be performed in a sequence different from or simultaneously with that of other blocks, which has been illustrated and described in this specification. Various other branches, flow paths, and sequences of blocks which achieve the same or similar results may be implemented. Furthermore, all the blocks illustrated in order to implement the method described in this specification may not be required.

In the description given with reference to FIG. 22, each of the steps may be further divided into additional steps or the steps may be combined into smaller steps depending on an implementation example of the present disclosure. Furthermore, some of the steps may be omitted, if necessary, and the sequence of the steps may be changed. Furthermore, the contents of FIG. 21, although some contents are omitted, may be applied to the contents of FIG. 22. Furthermore, the contents of FIGS. 21 and 22 may be applied to the contents of FIGS. 1 to 20, and the contents of FIGS. 1 and 20 may be applied to the contents of FIG. 21 or 22.

For example, the operating method of the labeling module M1 illustrated in FIG. 21 or the labeling system 100 illustrated in FIG. 22 may be applied to the method illustrated in FIG. 17. Specifically, step S530 or S540 of FIG. 21 may be applied to step S220 or S230. For example, in step S220, a label may be derived by comparing a keyword extracted from natural language explanatory notes with domain ontology data instead of a user input, or a label may be generated by using an LLM based on metadata or natural language explanatory notes. The classification model that is used in step S220 may include an LLM, and may be substituted with an LLM. Furthermore, the event label structuring information (i.e., event label schema) generated by the LLM-based label proposer 440 may be included in the labeling result structuring information of step S230. The classification model mounted on the labeling system 100 may be trained based on an event label that corresponds to domain ontology data or that is proposed by an LLM and that has high confidence (S240).

Furthermore, the consistent training process of the classification model introduced with reference to FIG. 17 may be applied to the method of FIG. 22.

Furthermore, some of or the entire labeling result structuring information in Tables 2 and 3 may be included in the event label schema that is used in FIG. 21 or 22.

Furthermore, the time-series data segment method of FIGS. 18 to 20 may be used in the Data Windowing of the labeling system 100 and the operating method thereof, which has been proposed with reference to FIG. 21 or 22.

Characteristics of the labeling system 100 and the operating method thereof according to an embodiment of the present disclosure, which are different from those of a conventional technology, may be listed as follows.

### (1) Detect Segment by Complexly Applying Statistics and Descriptions

The time-series data labeling system according to an embodiment of the present disclosure statistically finds a changepoint candidate (segment) and then proposes a natural language sentence and an event label that describe the segment by using an LLM.

(2) Convert Number into Meaning

The labeling system classifies a target segment as a category (e.g., very low, normal, or very high) by calculating the mean, a maximum, a minimum, a percentile, and a threshold. According to the embodiments disclosed in the present disclosure, the LLM safely generates explanatory notes according to criteria provided by the labeling system without arbitrary supposition.

### (3) Extend Ontology by Proposing Open-Label Event

The labeling system proposes a pattern that is not present in the existing ontology as a “new event” by using the LLM. When a user approves the proposed event, the corresponding event is automatically registered with ontology and is incorporated into the training of the labeling model operated by the labeling system.

### (4) Amateur-Friendly User Interface and Human-In-the-Loop (HITL) Through the User Interface

The labeling system simultaneously displays the labeling results of time-series data, a chart related to the labeling results, explanatory notes, and a numerical value base so that amateurs, such as farmers or site personnel, can easily understand the labeling results. A user who is an amateur can intuitively adjust the start point and end point of a segment by using a slider and a button that are provided by the user interface of the labeling system. The labeling system can automatically learn the results of the modification.

Although the present disclosure has been described with reference to the preferred embodiments, those skilled in the art may understand that the present disclosure may be modified and changed in various ways without departing from the spirit and scope of the present disclosure written in the claims.

Description of reference numerals

| | |
|---|---|
| 100: | time-series data labeling system |
| 110: | processor |
| 120: | communication device |
| 130: | memory |
| 140: | storage device |
| 150: | input interface device |
| 160: | output interface device |
| 170: | bus |

1. An operating method performed by a time-series data labeling system that comprises a processor and memory configured to store one or more commands executed by the processor and assigns labels to time-series data, the method comprising:
receiving first time-series data and source information of the first time-series data;
receiving, from a user, filtering condition information to be applied to filtering of the first time-series data, one or more labels to be applied to labeling of the first time-series data, and for each of the labels, a corresponding label segment that is a data range of the first time-series data, and performing labeling of the first time-series data; and
generating labeling result structuring information of the first time-series data, as a hierarchical representation of labeling results of the first time-series data, by arranging, in respective corresponding nodes of a predefined tree structure, the source information, the filtering condition information, a list of the labels, and correspondence information between the labels and the label segments.

2. The operating method of claim 1, further comprising training a classification model that is an artificial intelligence model that performs labeling of time-series data, by using the first time-series data and the labeling result structuring information of the first time-series data.

3. The operating method of claim 2, further comprising:
receiving second time-series data and source information of the second time-series data; and
performing labeling of the second time-series data by using the classification model and displaying results of the labeling of the second time-series data through the output interface device.

4. The operating method of claim 3, further comprising generating labeling result structuring information of the second time-series data based on the source information of the second time-series data and the results of the labeling of the second time-series data and displaying the labeling result structuring information of the second time-series data through the output interface device.

5. The operating method of claim 4, further comprising re-training the classification model by using the second time-series data and the labeling result structuring information of the second time-series data.

6. The operating method of claim 1, wherein the labeling result structuring information of the first time-series data is hierarchically structured information and comprises information that identifies and accesses the first time-series data and information on data items that are used in filtering in a process of labeling the first time-series data process.

7. The operating method of claim 1, wherein the input of the user comprises designating, by the time-series data labeling system, a data pattern that is used to extract candidate label segments from the first time-series data and selecting, by the time-series data labeling system, one or more label segments in the extracted candidate label segments based on the data pattern.

8. The operating method of claim 2, wherein the training of the classification model comprises requesting feedback from the user when prediction confidence calculated by the classification model is lower than a threshold and fine-tuning the classification model based on the feedback from the user.

9. The operating method of claim 8, wherein the feedback comprises excluding data having prediction confidence lower than the threshold, among the first time-series data, from training data for the training of the classification model.

10. A time-series data labeling system comprising:
one or more processors; and
a memory configured to store one or more instructions,
the one or more processors configured to execute the one or more instructions to:
receive first time-series data and source information of the first time-series data;
receive, from a user, filtering condition information to be applied to filtering of the first time-series data, one or more labels to be applied to labeling of the first time-series data, and for each of the labels, a corresponding label segment that is a data range of the first time-series data, and to perform labeling of the first time-series data; and
generate labeling result structuring information of the first time-series data, as a hierarchical representation of labeling results of the first time-series data, by arranging, in respective corresponding nodes of a predefined tree structure, the source information, the filtering condition information, a list of the labels, and correspondence information between the labels and the label segments.

11. The time-series data labeling system of claim 10, wherein the one or more processors are further configured to train a classification model that is an artificial intelligence model that performs labeling of time-series data, by using the first time-series data and the labeling result structuring information of the first time-series data.

12. The time-series data labeling system of claim 11, wherein the one or more processors are further configured to:
receive second time-series data and source information of the second time-series data; and
perform labeling of the second time-series data by using the classification model and to display results of the labeling of the second time-series data through the output interface device.

13. The time-series data labeling system of claim 12, wherein the one or more processors are further configured to generate labeling result structuring information of the second time-series data based on the source information of the second time-series data and the results of the labeling of the second time-series data and display the labeling result structuring information of the second time-series data through the output interface device.

14. The time-series data labeling system of claim 13, wherein the one or more processors are further configured to re-train the classification model by using the second time-series data and the labeling result structuring information of the second time-series data.

15. The time-series data labeling system of claim 10, wherein the labeling result structuring information of the first time-series data is hierarchically structured information and comprises information that identifies and accesses the first time-series data and information on data items that are used in filtering in a process of labeling the first time-series data process.

16. The time-series data labeling system of claim 10, wherein the input of the user comprises designating, by the processor, a data pattern that is used to extract candidate label segments from the first time-series data and selecting, by the processor, one or more label segments in the extracted candidate label segments based on the data pattern.

17. The time-series data labeling system of claim 11, wherein in training the classification model, the one or more processors are configured to request feedback from the user when prediction confidence calculated by the classification model is lower than a threshold and fine-tune the classification model based on the feedback from the user.

18. The time-series data labeling system of claim 17, wherein the feedback comprises excluding data having prediction confidence lower than the threshold, among the first time-series data, from training data for the training of the classification model.
